(19) United States
(12) Patent Application Publication
(10) Pub. No.: US 2008/0190398 A1
(43) Pub. Date: Aug. 14, 2008

(54) ENGINE WITH PISTONS ALIGNED PARALLEL TO THE DRIVE SHAFT

(76) Inventor: Marcel Geirnaert, Ternat (BE)

Correspondence Address: HOVEY WILLIAMS LLP, 10801 Mastin Blvd., Suite 1000, Overland Park, KS, 66210, US

(21) Appl. No.: 12/054,278

(22) Filed: Mar. 24, 2008

Related U.S. Application Data
(63) Continuation-in-part of application No. PCT/BE2006/000101, filed on Sep. 20, 2006.

(30) Foreign Application Priority Data
Sep. 23, 2005 (EP) 05 077 191.4

(51) Int. Cl. F02B 75/28

(52) U.S. Cl. 123/51 R; 92/69 R

(57) ABSTRACT

The parallel piston fuel engine has pistons arranged to move linearly along axes parallel to the central axis of the drive shaft of the engine. The engine includes at least one combustion chamber having two portions having central axes such that their central axes are not aligned.

The present invention is a continuation-in-part application of International Application No. PCT/BE2006/000101 filed on Sep. 20, 2006, published on Mar. 29, 2007 under number WO2007/033441, and claiming the priority of European patent application 05077191.4 filed on Sep. 23, 2005 and published under number 1770260 on Apr. 4, 2007, the entire disclosures of which are incorporated herein by reference.

### FIELD OF THE INVENTION

The present invention relates to a fuel engine, wherein the pistons are arranged to move linearly along axes parallel to the central axis of the drive shaft. The linear motion of a piston is converted into rotation by means of at least one swash plate. The heads of two pistons share the same combustion chamber. Thus, the engine is characterized by the opposing movements of pairs of pistons along axes parallel to drive shaft axis.

### THE STATE OF THE ART

Engines, wherein the pistons are arranged to move linearly along axes parallel to the central axis of the drive shaft are known for example, from EP 0 052 387 and U.S. Pat. No. 4,202,251, the entire disclosures of which are incorporated herein by reference. The problems with known engines comprising parallel-aligned pistons lie in the wear of the swash plates. The swash plate comprises an outer ring and an inner boss, which is held and rotates within the ring on a set of bearings, that are usually needle bearings. The boss is attached to the drive shaft at an inclined angle, so that linear movements of the ring by the pistons cause the inner boss and shaft to rotate. The swash plate experiences high revolutions and peak pressures, and often insufficient oiling of the joints between the boss and ring, and between the ring and piston.

### BRIEF DESCRIPTION OF THE INVENTION

The present invention provides a parallel piston engine having a better burning efficiency, and enabling a better burning of the fuel while having less noxious gases.

The present invention also provides a parallel piston engine enabling a better turbulence of the air or oxygen containing gas/fuel mixture in the combustion chamber.

The present invention further provides a parallel piston engine enabling a better filling of the combustion gases and/or a better exhaust of combustion gases.

The present invention provides also improvements to the engine, which leads to improved wear of the swash plates, reduced vibrational noise, more efficient combustion and movement by the pistons.

The engine of the invention is thus an improved engine enabling to solve one or more of the problems of the known engines and/or having one or more advantages with respect to the prior art parallel piston engine.

A first object of the invention is a fuel engine comprising

a drive shaft having a central axis;

at least one combustion chamber;

at least a first piston and a second piston arranged each to move along axes parallel to the central axis of the drive shaft, in which said first and second pistons share the same combustion chamber,

whereby the first piston is provided with a first piston rod adapted to rotate the drive shaft by means of a swash plate comprising a central assembly with a ring and at least one substantially spherical coupling element disposed on said ring, said coupling element on which the first piston rod or an element attached to the first piston rod is connected being distant from the central axis of a distance, while the second piston is provided with a second piston rod adapted to rotate the drive shaft by means of a swash plate comprising a central assembly with a ring and one or more substantially spherical coupling elements disposed on said ring, said coupling element on which the second piston rod or an element attached to the second piston rod is connected being distant from the central axis of a distance.

In the invention, the distance between the central axis of the drive shaft and the coupling element for the first piston rod is different from the distance between the central axis of the drive shaft and the coupling element for the second piston rod. By using such embodiment, it was possible to achieve a better linear motion with less vibration and noises.

Advantageously, the ratio D1/D2 is comprised between 1.01 and 3, preferably between 1.05 and 2, most preferably between 1.1 and 1.5, in which D1 is the distance between the central axis of the drive shaft and the coupling element for the first piston rod, while D2 is the distance between the central axis of the drive shaft and the coupling element for the second piston rod.

According to an advantageous embodiment, the first piston rod of the first piston has an axis located at a first distance from the central axis of the drive shaft, while the second piston rod of the second piston has an axis located at a second distance from the central axis of the drive shaft, said second distance being different from the first distance.

Preferably, for the distances separating the central axis of the drive shaft from the axis of the first and second rods, the ratio first distance/second distance is comprised between 1.01 and 3, advantageously between 1.05 and 2, preferably between 1.1 and 1.5.

According to another advantageous embodiment, the combustion chamber comprises a first portion in which the first piston is adapted to move, said first portion having a central axis, and a second portion in which the second piston is adapted to move, said second portion having a central axis, whereby the respective central axes of said first and second portions of the combustion chamber are not aligned.

According to still another advantageous embodiment, the combustion chamber comprises a first portion in which the first piston is adapted to move, said first portion having a first maximal expansion volume, and a second portion in which the second piston is adapted to move, said second portion having a second maximal expansion volume, whereby the maximal expansion volume of said first and second portions of the combustion chamber are different.

Preferably, the ratio first maximal volume/second maximal volume is comprised between 1.2 and 4, advantageously between 1.5 and 3, preferably between 1.8 and 2.5.

According to a detail the engine, the first portion of the combustion chamber is defined by a first inner diameter, while the second portion of the combustion chamber is defined by a second diameter, the ratio first diameter/second diameter being comprised between 1.01 and 2, advantageously between 1.05 and 1.5, preferably between 1.07 and 1.3.

According to another detail, the combustion chamber comprises a third portion located between the first and second portions of the combustion chamber, whereby said third portion is a portion in which the first piston and the second piston do not move, said third portion, possibly one or more hollow zones of the first and/or second pistons forming the minimum dead volume when the pistons are adjacent.

According to a specific embodiment of the engine, for each swash plate, the ring is mounted rotative along an axis with respect to the central assembly, by means of at least two bearings, whereby said axis forms an angle with the central axis of the drive shaft. The at least two bearings rotatably mount the ring to the swash plate so that the ring rotates about an axis of rotation, the axis of rotation of the ring forming an angle with the central axis of the drive shaft.

Advantageously, the axis of rotation of the ring forms an angle comprised between 10° and 50°, advantageously between 15° and 40° with respect to the central axis of the drive shaft.

Preferably, the ring has an inner diameter, whereby the distance between the bearing is substantially equal to the inner diameter of the ring divided by the tangent of the angle formed between the axis of rotation of the ring and the central axis of the drive shaft.

According to a further embodiment, the central assembly 47 of the swash plate adapted to rotate around an axis of rotation is provided with a bore having a central axis forming an angle with the axis of rotation, said angle being advantageously comprised between 10° and 40°, preferably in the range 20° to 25°.

According to a further detail, the pistons connected to a swash plate are configured such that distance, d2, between the longitudinal axis of the drive shaft, and the longitudinal axis of each piston rod is minimized.

According to still a further detail of an embodiment, one or more of the elements selected from the group consisting of spherical coupling elements of a swash plate, the ring, the central assembly, the drive shaft, seating members, the connected piston rods, or the piston heads comprise at least one internal channel for the passage of lubricating oil.

Advantageously, two or more of said channels have one or more openings or ends adapted to form a passage therebetween.

Preferably, the openings or ends are adapted to form temporary passage therebetween.

According to an embodiment, it further comprises a lubricated piston ring assembly, advantageously formed from concentric rings, preferably a pair of concentric rings, each ring being advantageously provided with an expansion slit, and a circular wick concentrically arranged within said rings, disposed in a groove around the cylindrical surface of a piston and which contacts a cylinder wall.

According to an embodiment comprising a flywheel and a combustion chamber comprising two cylinders in which the pistons are moving, the cylinder proximal to the flywheel is advantageously larger in volume than the opposing cylinder located distal to the flywheel, and/or the cylinder proximal to a flywheel is larger in diameter than an opposing cylinder located distal to the flywheel, and/or the central axis of the cylinder proximal to the flywheel and the central axis of the cylinder distal to the flywheel are not aligned, and the latter being closer to the drive shaft, so providing an asymmetric or eccentric combustion chamber.

Advantageously, the combustion chamber comprises an interface between the cylinder proximal to the flywheel and the cylinder distal to the flywheel, advantageously between the larger and smaller cylinders, said interface being provided with at least one fuel entry point.

According to details of specific embodiments (the embodiments having one or more of said details),

at least one swash plate has a ring adapted to be coupled to a mechanically-driven compressor suitable for injecting fuel and/or air mixtures, and/or

at least one piston, preferably the two pistons moving in a combustion chamber is/are provided with a piston head surface provided with an indent which is advantageously deeper towards the centre of the piston head surface, most preferably, the combustion chamber having at least one fuel entry point, whereby the said indent is deeper in the vicinity of fuel entry point and shallows out in the direction away from the fuel entry point, and/or

a flywheel, attached to the end of the drive shaft comprises at least two coaxial elements and defining a space there between having a volume, a first element being attached to the drive shaft and being able to slightly slide along the drive shaft, while the other element is provided with a set of bolts configured to move the element away from element, so changing the volume of the space between the elements (Preferably, by increasing the space, through the intermediary of a cylindrical body attached to the other element, the position of the swash plate proximal to the flywheel is adjustable), and/or

the combustion chamber is provided with regular air inlets and/or exhaust ports, said inlets and ports being aligned circumferentially in the wall of the combustion chamber, such that the cylindrical wall of at least one piston, advantageously two pistons moving in the combustion chamber being adapted for closing one or more air inlets and/or exhaust ports when said cylindrical wall is positioned thereover (Advantageously, the axial position of the regular air inlets is such that they are fully open when a piston distal to the flywheel is retracted, and close when said piston moves forward. Preferably, the axial position of the exhaust ports is such that they are fully open when the piston proximal to the flywheel is retracted, and close when said piston moves forward) and/or

the engine comprises at least two combustion chambers, each chamber being provided with two moving pistons, all said pistons moving in their respective combustion chamber in a direction parallel to the central axis of the drive shaft, and/or

the fuel engine further comprises a turbocharger or means for connecting it to a turbocharger (Advantageously, the turbocharger is provided with an air outlet disposed with a valve adapted or controlled to remain closed in function of the pressure, advantageously until generated pressure reaches a predetermined level. Preferably, the turbo air inlets are aligned circumferentially in the wall of the combustion chamber in the same circumferential ring as the regular air inlets. Most preferably, the turbo air inlets are longer in the direction towards the exhaust ports than the regular air inlets), and/or

the fuel engine is configured such that air entering the combustion chamber through the regular air inlets comprises the air displaced from a void or free space behind a piston during the retracting motion of the piston, and/or

the fuel engine comprises a flywheel, whereby one piston is proximal to said flywheel, while the other is distal to said flywheel, the engine being configured such that the piston proximal to the flywheel moves in advance of the piston distal thereto (said advance is advantageously more than 0° and less than 10°).

The invention further relates to a fuel engine comprising

a drive shaft having a central axis;

at least one combustion chamber;

at least a first piston and a second piston arranged each to move along axes parallel to the central axis of the drive shaft, in which said first and second pistons share the same combustion chamber,

whereby the first piston is provided with a first piston rod adapted to rotate the drive shaft by means of a swash plate comprising a central assembly with a ring and at least one substantially spherical coupling element disposed on said ring, said coupling element on which the first piston rod or an element attached to the first piston rod is connected being distant from the central axis of a distance, while the second piston is provided with a second piston rod adapted to rotate the drive shaft by means of a swash plate comprising a central assembly with a ring and one or more substantially spherical coupling elements disposed on said ring, said coupling element on which the second piston rod or an element attached to the second piston rod is connected being distant from the central axis of a distance,

in which for each swash plate, the ring is mounted rotative along an axis with respect to the central assembly (the ring is rotatably mounted to the central assembly of the swash plate for rotation about an axis), by means of at least two bearings, whereby said axis forms an angle with the central axis of the drive shaft comprised between 10° and 50°, advantageously between 15° and 40°, more specifically of about 20° to 25° with respect to the central axis of the drive shaft, and

in which the ring has an inner diameter, whereby the distance between the bearings is substantially equal to the inner diameter of the ring divided by the tangent of the angle formed between the axis of rotation of the ring and the central axis of the drive shaft.

Said engine has advantageously one or more further advantages or details of the fuel engine according to the first object of the invention.

The invention still further relates to a fuel engine comprising:

a drive shaft having a central axis;

at least one combustion chamber comprising at least one inlet for an oxygen containing gas and at least one outlet for combustion gases;

at least a first piston and a second piston arranged each to move along axes parallel to the central axis of the drive shaft, in which said first and second pistons share the same combustion chamber,

whereby the first piston is provided with a first piston rod adapted to rotate the drive shaft by means of a swash plate comprising a central assembly with a ring and at least one substantially spherical coupling element disposed on said ring, said coupling element on which the first piston rod or an element attached to the first piston rod is connected being distant of a distance from the central axis, while the second piston is provided with a second piston rod adapted to rotate the drive shaft by means of a swash plate comprising a central assembly with a ring and one or more substantially spherical coupling elements disposed on said ring, said coupling element on which the second piston rod or an element attached to the second piston rod is connected being distant of a distance from the central axis,
in which for each swash plate, the ring is mounted rotative along an axis with respect to the central assembly (the ring is rotatably mounted to the central assembly of the swash plate for rotation about an axis), by means of at least two bearings, whereby said axis forms an angle with the central axis of the drive shaft (29) comprised between 10° and 50° with respect to the central axis of the drive shaft, and
in which the said bearings are selected among the group consisting of low friction slide bearings, self lubricating slide bearings, slide bearings provided with at least one lubrication channel, and combinations thereof.

The said bearings are for example ring shaped. The said bearing are for example in the form of a metallic matrix comprising solid lubricant, rings provided with channels for oil, grease, etc. The channels are for example in the form of grooves extending on one or both flat faces of the ring. One or more channels are provided with one or more openings or inlet passages adapted with a oil feeding system, such as an oil feeding system adapted to inject continuously or not oil into one or more channels, or parts thereof.

Said engine has advantageously one or more further advantages or details of the fuel engine according to the first and/or the second object of the invention.

A fourth object of the invention is a fuel engine having one or another detail, especially several details as disclosed here above for any or all the first, second and third objects of the invention.

Especially, the invention further relates to a fuel engine comprising:

a drive shaft having a central axis;

at least one combustion chamber;

at least a first piston and a second piston arranged each to move along axes parallel to the central axis of the drive shaft, in which said first and second pistons share the same combustion chamber,

whereby the first piston is provided with a first piston rod adapted to rotate the drive shaft by means of a swash plate comprising a central assembly with a ring and at least one substantially spherical coupling element disposed on said ring, said coupling element on which the first piston rod or an element attached to the first piston rod is connected being distant of a distance from the central axis of a distance, while the second piston is provided with a second piston rod adapted to rotate the drive shaft by means of a swash plate comprising a central assembly with a ring and one or more substantially spherical coupling elements disposed on said ring, said coupling element on which the second piston rod or an element attached to the second piston rod is connected being distant of a distance from the central axis,

said fuel engine having one or more of the following characteristics,

advantageously a combination of at least two, preferably at least three of the following characteristics:

A. The ring is mounted on the central assembly by means of two bearings. The ring has two opposite edges, whereby a first bearing acts on a first edge of the ring, while the other bearing acts on the other edge of the ring. The ring has an axis of relative rotation with respect to the central assembly, whereby an angle β is formed between said axis of relative rotation of the ring with respect to the central assembly and the central axis of the drive shaft. The distance between the two opposite edges or between the two bearings is maximized, said distance being substantially equal to the inner diameter of the ring divided by the tangent of said angle β. Said angle is advantageously about 20° to 25°.

In case the inner shape of the ring is not substantially cylindrical, the distance between the edges or bearings will be equal to about the average inner diameter of the ring (said average being for example the average diameter measured at the edges of the ring) divided by the tangent of the angle defined between a plane tangential to the two edges of the ring, and the central axis of the driving shaft.

B. The combustion chamber comprises two portions connected there between, a first piston movable in the first portion, while the second opposite piston is movable in the second portion. The first piston has a diameter different from the second piston, for example 10% to 50% smaller than the diameter of the second piston.

C. The combustion chamber comprises two portions connected there between, a first piston movable in the first portion, while the second opposite piston is movable in the second portion. The first portion has a maximum volume (volume variation measured between the position of the first piston adjacent to the second piston and the position of the first piston moved the most away from the second piston) which is different from the maximum volume of the second piston (volume variation measured between the position of the second piston adjacent to the first piston and the position of the second piston moved the most away from the first piston). For example the first portion has a maximum volume 10% to 50% smaller than the maximum volume of the second portion.

D. The combustion chamber comprises two portions connected there between, a first piston movable in the first portion, while the second opposite piston is movable in the second portion. The first portion being eccentrated (offset, differently sized, and/or asymmetric) with respect to the second portion.

E. The combustion chamber comprises two portions connected there between, a first piston movable in the first portion, while the second opposite piston is movable in the second portion. The two portions are connected there between by an interface portion provided with the fuel ignition means and/or the fuel inlet means (for example injection means). The first and/or second pistons are provided with an indent.

F. the pistons are provided with a lubricated piston ring assembly.

G. The fuel engine is provided with a means for adapting the end positions of the first and/or second piston in the combustion chamber.

H. The first and second pistons move each between two end positions, whereby the movement of one piston is in advance with respect to the movement of the other piston, said advance being advantageously comprised between 0.1 and 10°.

I. The combustion chamber forms at least behind a piston at least a room or void adapted to be filled with air or another gas when said first piston moved towards the other piston. The fuel engine is provided with means for directing air or gases from said room or void towards a combustion chamber or a buffer chamber prior the filling of a combustion chamber when said first piston is moved away from the other.

The invention still further relates to the use of one or more engines of the invention for generating a power or a driving force, especially a rotating driving force. Especially, the invention relates to the use of one or more engines of the invention for modifying the compression ratio and/or for ensuring a substantially stratified combustion.

The invention further relates to a method for generating a power or a driving force, including providing a fuel engine of the type described herein having two or more pistons which move along axes parallel to a central axis of a drive shaft of the engine.

In an embodiment of said method utilizing the provided fuel engine, the method comprises at least the steps (iterations of series of at least successive following steps):

inlet stroke or filling of the combustion chamber with at least a fuel and an oxygen containing gas during at least a portion of the period when the pistons of the combustion chamber are moved away from each other by moving into rotation the drive shaft through the movement of the swash plates thereof,

compression stroke or compressing the fuel and the oxygen containing gas by moving the pistons of the combustion chamber the one towards the other by moving into rotation the drive shaft through the movement of the swash plates,

expansion stroke or burning the fuel so as to generate combustion gases, said combustion gases generating pressure in the combustion chamber, said pressure causing the movement of the pistons away from each other, whereby generating the rotation of the drive shaft through the movement of the swash plates,

exhaust stroke or exhausting the combustion gases outside the combustion chamber at least during the movement of the pistons of the combustion chamber towards each other by moving the drive shaft in rotation through the swash plates.

According to another embodiment of the method utilizing the provided fuel engine, the method comprises at least the steps (iterations of series of at least successive following steps)

inlet stroke or filling of the combustion chamber with an oxygen containing gas during at least a portion of the period when the pistons of the combustion chamber are moved away from each other by moving into rotation the drive shaft through the movement of the swash plates thereof,

compression stroke or compressing at least partly the oxygen containing gas by moving the pistons of the combustion chamber the one towards the other by moving into rotation the drive shaft through the movement of the swash plates,

injecting fuel in the combustion chamber,

expansion stroke or burning the fuel so as to generate combustion gases, said combustion gases generating pressure in the combustion chamber, said pressure causing the movement of the pistons away from each other, whereby generating the rotation of the drive shaft through the movement of the swash plates,

exhaust stroke or exhausting the combustion gases outside the combustion chamber at least during the movement of the pistons of the combustion chamber towards each other by moving the drive shaft in rotation through the swash plates.

### BRIEF DESCRIPTION OF THE FIGURES

FIG. 1 is a partial cross section through an engine with parallel-aligned pistons.

FIG. 2 is an exploded view of a piston suitable for an eight piston engine, and its cylindrical guidance system, connected to a swash plate.

FIG. 2A is an exploded view of a piston suitable for a four piston engine, connected to a swash plate.

FIG. 3 is a view of a swash plate equipped with two spherical coupling elements, one of which is connected to a cylindrical member housed between two profiled guides.

FIG. 4 is a view of a swash plate equipped with four spherical coupling elements, and a cylindrical member housed between two profiled guides.

FIG. 5 is a transverse cross-section through a swash plate.

FIG. 6 a partial longitudinal cross section through a swash plate.

FIG. 7 a cross section through a swash plate and piston, indicating lubricating fluid channels.

FIG. 8 is a cross section through an engine of the present invention, indicating lubrication channels, differentially sized and positioned cylinders, and the position of the point of fuel entry.

FIG. 9 is a view of the engine according to the present invention, viewed along the line of site Y in FIG. 10.

FIG. 10 is a cross-sectional view of an engine of the present invention depicting a compressor and an arrangement of inlet and outlet chambers.

FIGS. 11A to H are longitudinal cross-sectional views through a combustion chamber of a set of opposing pistons, indicating the position of the inlet and exhaust ports and the cycle of the engine.

FIG. 12 is a transverse cross-sectional view through the cylinders of an engine indicating the position of the turbo air inlets and one way valve.

FIG. 13 is a transverse cross-sectional view through a piston, indicating the piston ring elements.

FIGS. 14A to 14C are upper, lower, side views of a slide bearing, while FIG. 14D is a cross section view of the slide bearing along the line XIV-XIV.

FIG. 15 is a cross section view of a swash plate with lubricated bearings of the type shown in FIGS. 14A to D.

### DETAILED DESCRIPTION OF AN PREFERRED EMBODIMENT OF THE INVENTION

Unless defined otherwise, all technical terms used herein have the same meaning as is commonly understood by one of skill in the art. All publications referenced herein are incorporated by reference thereto. All United States patents and patent applications referenced herein are incorporated by reference herein in their entirety including the drawings.

The articles “a” and “an” are used herein to refer to one or to more than one, i.e. Lo at least one of the grammatical object of the article. By way of example, “a channel” means one channel or more than one channel.

The recitation of numerical ranges by endpoints includes all integer numbers and, where appropriate, fractions subsumed within that range (e.g. 1 to 5 can include 1, 2, 3, 4 when referring to, for example, a number of pistons, and can also include 1.5, 2, 2.75 and 3.80, when referring to, for example, distances).

Fuel means any fuel suitable for engine combustion, including, but not limited to petrol (gasoline), diesel, oil, gas, methane, propane, etc., and combinations thereof.

The present invention relates to an engine wherein the pistons are arranged to move along axes parallel to the central axis of the drive shaft, in which a pair of pistons share the same combustion chamber, and the linear motion of piston rods rotate the drive shaft by means of two swash plates. Such engines and variations thereof are known the art for example, from EP 0 052 387 and U.S. Pat. No. 4,202,251 the entire disclosures of which are incorporated herein by reference. Such an engine is referred here as a “parallel piston engine” (PP engine), in view of the parallel arrangement of pistons with respect to the drive shaft.

For clarity, a technical description of a PP engine follows with reference to the figures. The figures are used only illustrate the description of the PP invention; other designs and configurations of PP engines that can be implemented by the skilled person are within the meaning of a PP engine.

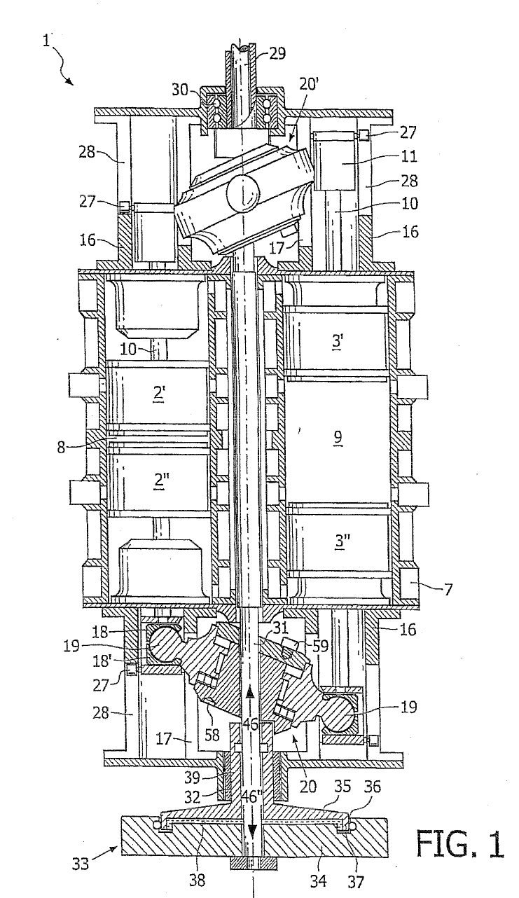

The PP engine according to the embodiment in FIG. 1 comprises an engine block 1 in which pistons 2′, 2″ and 3′, 3″ are disposed, two by two so that pairs of opposing pistons share the same combustion chamber 8 or 9. The wall of the combustion chamber can in an advantageous embodiment be coated with a ceramic layer or can be made in a ceramic material. Other material, such aluminum containing alloys are also suitable, even if ceramic is preferred.

The number of pistons in a PP engine according to the present invention is preferably a multiple of two e.g. 2, 4, 6, 8, 10, 12, 14 or 16. FIG. 1 refers to a type of engine comprising four pairs of opposing pistons (i.e. 8 pistons). Discussed further below is a PP engine comprising 2 pairs of cylinders (i.e. 4 pistons).

The combustion of the fuel mixture in each combustion chamber 8 or 9 proceeds by known means and is not elaborated here. The ignition can be operated or controlled by a spark plug, by compression, and/or by any other means.

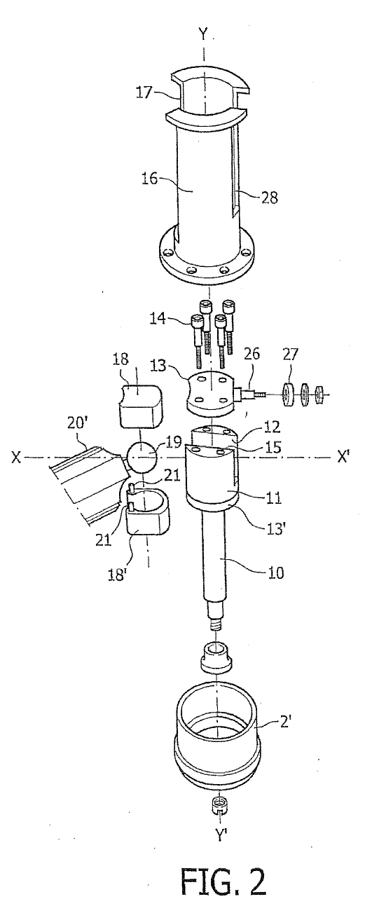

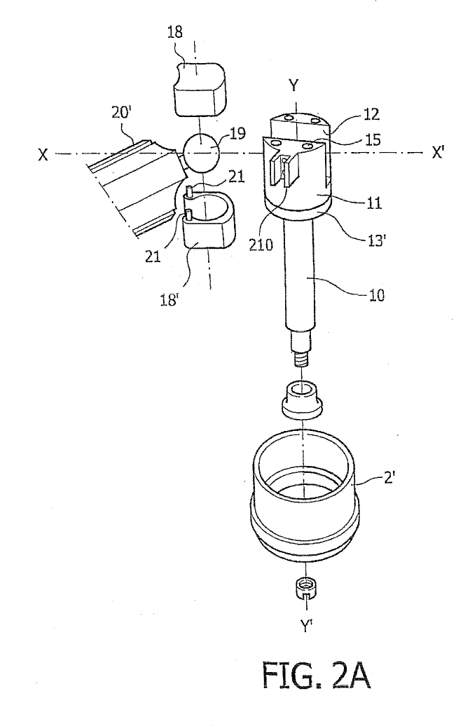

To transmit a linear movement of a piston to the swash plate, each piston 2′, 2″, 3′ and 3″, is rigidly connected to a piston rod 10. The elements of the piston, piston rod and the associated slide blocks are indicated in FIG. 2, which is an exploded view of a piston rod 10 connected to a piston 2′ at one end, and to a slide block 11 at the other end. The slide block 11 comprises a central housing with two parallel walls 12 capped by a lid 13 which tightens to the slide block 11 using four screws 14 that pass though four openings 15 and screw to a lower plate 13′ of the slide block 11. Slide block 11 may be encased in a cylinder 16 which may in practice be a cylindrical cavity of the engine block. The cylinder comprises a first slit 17 whose width is sufficient to allow the movements of the swash plate 20′. The width of housing between faces 12 of the slide block is equal to, or slightly greater than the width of parallel faces of the seating members 18, 18′. The seating members 18, 18′, when assembled together, house within it a spherical coupling element 19 of the swash plate 20′.

The halves of the seating members 18, 18′ locate each other properly owing to lugs 21 present on one of the seating members 18′ which couple upon assembly with openings (not shown) present on the opposing seating member 18.

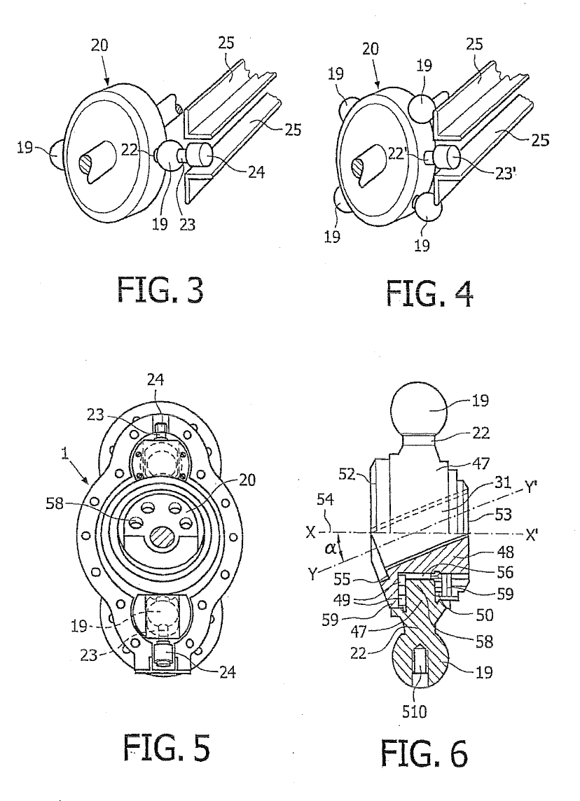

In a PP engine with only one or two spherical coupling elements, the swash plate is configured to move only in one plane, which plane is defined by the plane of symmetry of the housing (X-X′ in FIG. 2) and thus also by the axis of piston rod 10.

Where the PP engine equipped with a swash plate comprising two spherical coupling elements, seating members 18-18′ housing spherical coupling element 19 slide without play along faces 12 of above mentioned housing. In a PP engine in which swash plate 20′ is equipped with two spherical coupling elements 19 for two pairs of pistons, a cylindrical member 24 may be provided which is an extension of the spherical coupling 23 (FIG. 3). The cylindrical member is configured to fit between a profiled guiding means 25. The profiled guiding means 25 between which the cylindrical member 24 moves prevents rotation of the outer ring of the swash plate 20′.

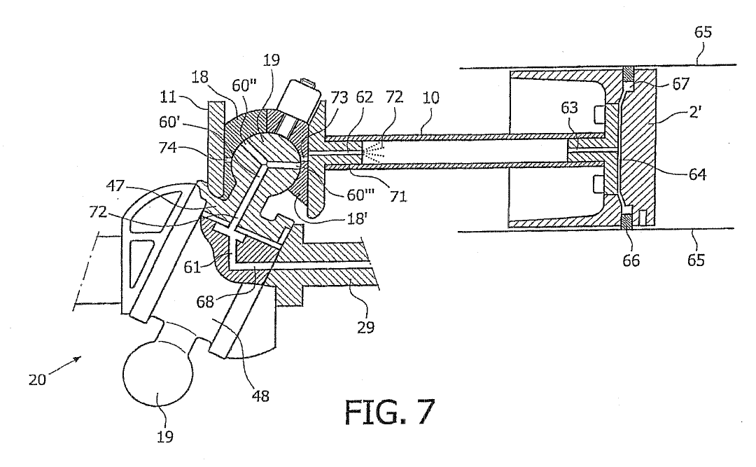

The rotation of a piston, 2′ (FIG. 2) in an engine disposed with a four-spherical coupling swashplate is prevented by the presence on the lid 13 of the slide block 11 of a pivot 26 with cylindrical member 27, trapped between the opposite faces of a longitudinal slit 28, present on cylinder 16, opposite to the broad slit 17. Owing to this configuration no or little lateral force is exerted either on the slide block 11, nor on the piston rod 10. Seating members 18-18′ as well as cylindrical member 27 can also be seen on part of FIG. 1.

Where a PP engine has four pairs of pistons and thus four spherical coupling elements, the pivot 22′ with cylindrical member 23′ can be located and placed between two spherical coupling elements 19 (FIG. 4).

Where an engine comprises a swashplate with two spherical couplings, the rotation of a piston, 2′ (FIG. 2A) may be prevented by the presence on the slide block 11 of a protrusion with flat ridges 210, which is guided within a reciprocating elongate slot in the engine block or in a cylinder 16. Again, this configuration provides no or little lateral force either on the slide block 11, or on the piston rod 10.

While referring once again to FIG. 1, it shows two pairs of opposing pistons, each pair (2′, 2″ or 3′, 3″) connected to a separate swashplate; the pistons 2′, 3″ transmit force, via rods 10 and slide blocks 11 to the spherical coupling elements 19, which are not visible in the upper part of the figure, pertaining to the swash plates represented by the general reference 20′. Cylindrical members 27 as well as the opposing slits 17 and 28 are also visible in this upper part of FIG. 1.

The swash plate 20′ is fixed on the drive shaft 29, said drive shaft being mounted on the engine block via a ball bearing 30 joint. The swash plate 20 indicated in the lower represented part of FIG. 1, proximal to the flywheel 33, is assembled on the same drive shaft. The mechanism for converting the translation movement of the pistons into rotational movement by the drive shaft (i.e. the swash plate) is discussed later below.

The driving shaft 29 may be coupled to the end of the engine block distal to the flywheel by ball bearing coupling 30, and at the end proximal to the flywheel by means of a smooth bearing 32. The flywheel 33, attached to the latter end of the drive shaft 29 may comprise two coaxial elements 34 and 35.

Element 34 attached to the drive shaft 29 may present a niche 36 for the circular edge 37 of element 35 of the fly wheel 33. Element 35 is able to slightly slide along the drive shaft 29 but does not rotate with the drive shaft 29. The rotation of the drive shaft 29 and element 35 of fly wheel 33 are obviously independent. As already mentioned above, the means of guidance (e.g. 26, 27, 22′, 23′, 16) ensures the pistons 2′, 2″ and 3′, 3″ and slide block 11 move in a linear mode. In addition, motion is restricted to a linear movement owing to the design of the assembly between seating members 18, 18′ and spherical coupling elements 19 of the swash plates 20 or 20′ (FIG. 2). When a swash plate is equipped with two spherical coupling elements, movement of the swash plate proceeds in one plane which encompasses the longitudinal axis of the drive shaft 20′ and the longitudinal axis (Y-Y′, FIG. 2) of piston rods 10. On the other hand, when an oscillating plate is equipped with four spherical coupling elements 19, each one of those roughly follows a ‘figure of 8’ trajectory. When use is made of a swash plate with four spherical coupling elements 19, there is generally little or no play inside housing 12 between the base of this housing, forming the base of the slide block and the lower face of lid 13 (FIG. 2). On the other hand, there is some play between the parallel faces 12 of housing as well as a translation or back and forth movement inside this housing, because of the upwards and downward swings of each spherical coupling element 19 inside each corresponding residences of slide blocks 11.

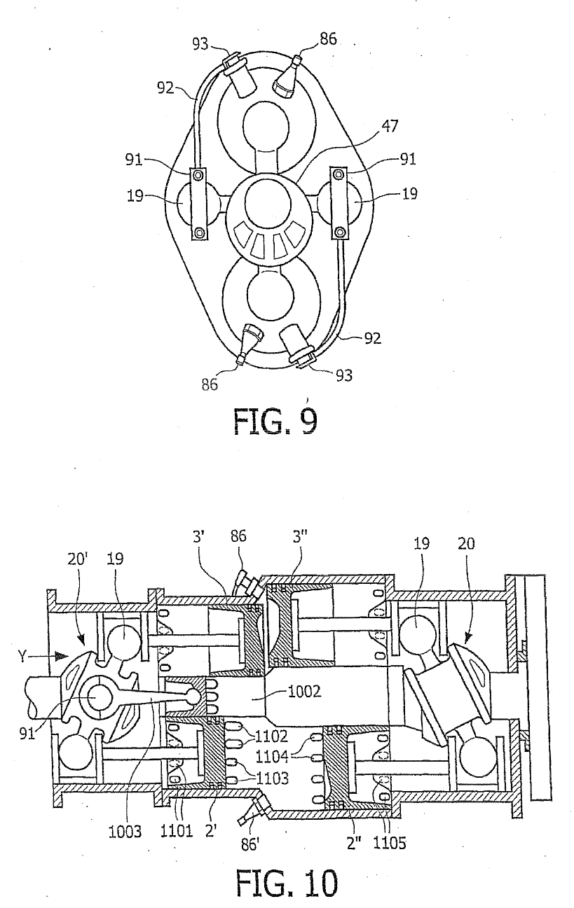

FIG. 6 shows a swash plate comprising a ring 47 bearing at least two spherical coupling elements 19 diametrically opposed, joined together with ring 47 by a collar 22. Ring 47 is coupled to a central boss 48 and is able to rotate relative to the boss by way of a first bearing 49 and a second bearing 50 disposed either side of said ring 47. Said first 49 and second 50 bearings are preferably needle bearings.

The central boss 50 is maintained in position within the ring 47 by an annular projection of the central boss 58, and an annular elements mounted on the ring 59.

Bearing 50 may be further maintained in position within the ring 47 by a circular element.

Where the bearings 49, 50 are needle bearings, the cylindrical elements can be made up of two or three coaxial elements. This provision is designed to take account of the variations in angular velocity which these elements undergo when one considers the rotation of the central boss 48 compared to the ring 47.

The central boss 48 comprises a central bore 31, whose internal diameter may correspond to the external diameter of the drive shaft 29. The boss 48 has two external sides 52 and 53 which are parallel to each other. However, the side of the boss 48 which is proximal to the cylindrical body 39 from the fly wheel, can be configured to contact the cylindrical body 39. Accordingly the boss may be disposed with a niche 55 which can accommodate the co-operating edge of the cylindrical body. Also indicated in FIG. 6 is the bore 31 which rotates with central boss 48 of the swash plate and allows the axial displacement movement to drive shaft 29.

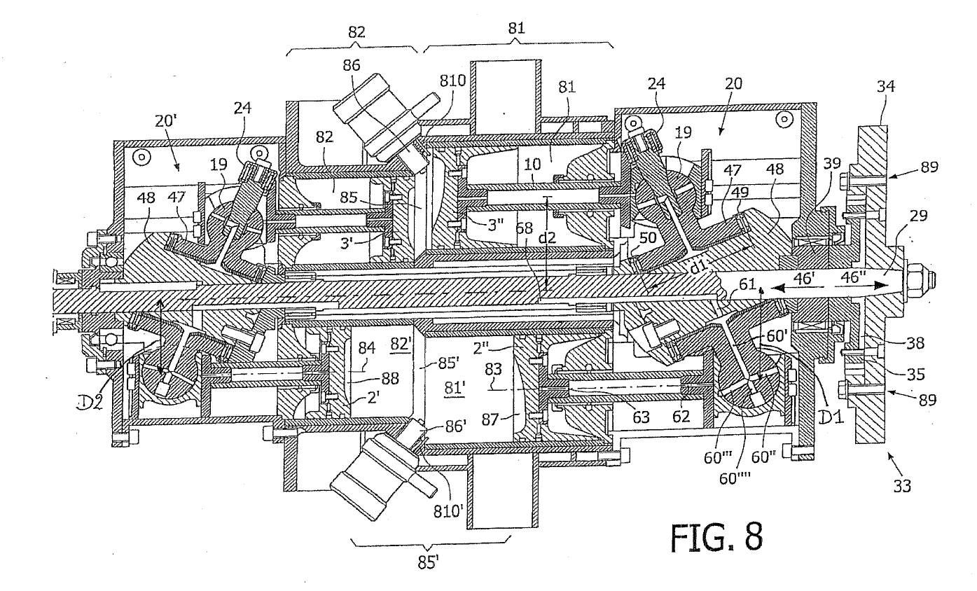

A needle bearing, or, in the event of force feed lubrication, a smooth bearing, may be disposed between the ring 47 and the boss 48 as indicated by reference 56 in FIG. 6. Means of balancing the boss may comprise openings 58 (FIG. 5, FIG. 1), on the one hand, and bolts 59 (FIG. 1), on the other hand, present in the external sides 52 and 53 of the central boss 48.

In FIG. 6 one of spherical coupling elements 19 presents a tapped axial boring 510 in which a collar 23 of a cylindrical member 27 can be screwed, such elements as represented on FIG. 3.

The present invention relates to improvements to the basic concept of the PP engine. The PP engine is not limited to the description above, which is merely given for illustrative purposes, but can be applied to any suitable PP engine.

Reference is made in the description below to the drawings which exemplify particular embodiments of the invention; they are not at all intended to be limiting.

The skilled person may adapt the improved PP engine and substituent components and features according to the common practices of the person skilled in the art.

Wear to the Swash Plates.

PP engines suffer from wear of the swash plate owing to the forces applied between the joints which translate the lateral movement of the pistons into rotational movement by the drive shaft. Improvements to the design of the swash plate by the present inventor have surprisingly lead to a better distribution of forces within the swash plate bearings, which improvements do not require more heavily engineered components, or more substantial bearings.

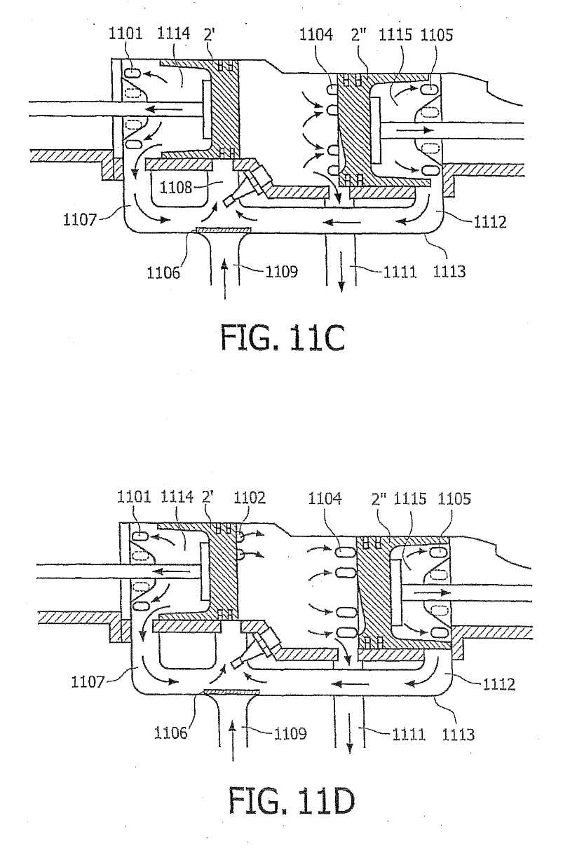

One embodiment of the present invention is a PP engine wherein the distance, d1 (FIG. 8), between the first 49 and second 50 bearings of the swash plate 20, 20′ is maximized, and the spherical coupling element 19 is positioned midway between the two bearings. Distance d1 is limited by distance between the piston 2′, 2″ and the drive shaft 20; the further apart they are, the larger distance d1 may be set.

Distance d1 for a particular drive shaft/piston configuration may be maximized when proximity of one bearing 50 to the drive shaft 29 is minimized. This can be seen, for example in FIG. 8 wherein one bearing 50 contacts to drive shaft 29 and hence the distance is minimized. The distance d1, therefore, can be readily calculated by the person skilled in the art based on the distance (d2, FIG. 8) between the longitudinal axis of the drive shaft 29, and the longitudinal axis of the piston rod 10. Increasing the distance between the bearings 49, 50 surprisingly allows the swash plate to absorb peak pressures, and alleviates stresses to the bearings.

The inventors have also found that less wear is placed on the swash plates 20 when the pistons 2′, 2″, 3′, 3″ or cylinders 81, 81′, 32, 82″ are placed as close as possible to the drive shaft 29. When the distance between the longitudinal axis of the drive shaft 29, and the longitudinal axis of the piston rod 10 (d2) is minimized, the leverage effect of the spherical element is reduced, and consequently less stress on the joint between the ring 47 and the spherical coupling element 19. Furthermore, the core of the swash plate experiences reduced stresses.

The bearings 49, 50 used in the above description of the swash plate can be any suitable joint flanking the annular projection of the central boss 58. For example, the bearings may be ball-bearings, single or double needle bearings, lubricated joint, ceramic joint etc. Where, for example, petrol is the fuel, the bearings should be capable of high performance owing to the higher rpm; consequently, the joint may comprise a double layer of needle bearings, or a single layer of high capacity needle bearings. Conversely, where the fuel is diesel, the bearing may be of a lesser specification owing to the lower rpm; as a result, the bearing may a single layer of needle bearings.

For a swash plate, the ring (47) is mounted rotative along an axis with respect to the central assembly (48), by means of at least two bearings (49,50), whereby said axis forms an angle with the central axis of the drive shaft (29).

The axis of rotation of the ring forms an angle comprised between 10° and 50°, advantageously between 15° and 40°, preferably about 20°-25° with respect to the central axis of the drive shaft (29).

The ring (47) has an inner diameter, whereby the distance between the bearing is substantially equal to the inner diameter of the ring (47) divided by the tangent of tie angle formed between the axis of rotation of the ring and the central axis of the drive shaft, so as to maximize (d1).

Angle of Inclination

One embodiment of the present invention is a PP engine wherein in the central axis of the boss bore 31 and the axis of rotation of the boss adopt an angle (alpha, FIG. 6) of 15°, 16°, 17°, 18°, 19°, 20°, 21°, 22°, 23°, 24°, 25°, 26°, 27°, 28°, 29° or 30°, or a value in the range between any two of the aforementioned values.

Preferably, alpha is in the range 20° to 25°, even more preferably it is about 23°. It has been found that angle within the above mentioned range (15° to 30°) reduces stress to the swash plate, and stimulates rotation of the drive shaft as the drive behaves more like a crankshaft.

Lubrication

PP engines generally suffer from poor lubricant distribution owing partly to the number of components and large area to be lubricated. The high rpm of PP engines means lubricant is ejected from moving parts by centrifugal force. Lubrication is essential owing to the peak pressures experienced by the components, in particular the swash plate. The present invention provides a lubrication system as a series of internal channels provided in the components of the most active joints.

One embodiment of the present invention is a PP engine wherein one or more (e.g. 2, 3, 4, 5, 6, 7 or all) of the spherical coupling elements 19 of a swash plate 20, the ring 48, the connected boss 48, the drive shaft 29, seating members 18′, the connected piston rod 10, or the piston head comprise at least one internal channel for the passage of lubricating oil. The channels between at least two of the aforementioned components may be connected, where appropriate. Where Two of the aforementioned components are co-operatively connected and move relative to each other during running of the PP engine, said components may be configured to temporarily connect where appropriate. Such temporary connection of channels may be achieved, for example, when the respective channels align momentarily as one component moves past the other (e.g. as seen in the movement of the spherical coupling element 19 across the seating member 18′)

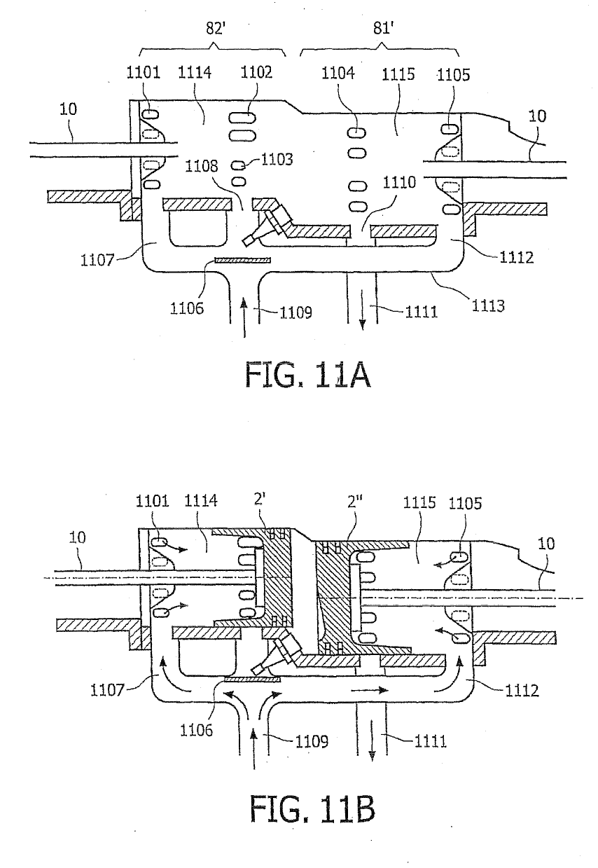

According to one embodiment of the present invention, as exemplified in FIG. 7, the spherical coupling element 19 comprises a plurality of internal channels 60, 60″, 60′″ suitable for the passage of lubricating oil, which are configured to connect with a channel 72 in the ring 47 and temporarily connect with channels 74, 73 in the seating member 18, 18′. According to another aspect of the invention, the boss 48 comprises an internal channel 61 configured to connect with a channel 68 in or on the drive shaft 29 and configured to temporarily connect with a channel 72 in the ring 47. According to another aspect of the invention, the piston rod 10 comprises one or more internal channels 62 configured to temporarily connect with a channel 73 in the seating member 18′. According to another aspect of the invention, the piston rod 10 comprises an internal channel 63 which connects with a channel 64 in the piston 2′. According to another aspect of the invention, the piston 2′ comprises an internal channel 64 which provides lubrication to a groove 67 in the wall of piston 2′. According to another aspect of the invention, either or both halves of the seating member 18, 18′ comprises an internal channel 74, 73 configured to temporarily connect with a corresponding internal channel 60″, 60′″in the spherical coupling element 19. According to another aspect of the invention, the ring 47 comprises an internal channel 72 configured to connect with a channel 60′ in the spherical coupling element 19, and temporarily connect with a channel 61 in the boss 48. According to another aspect of the invention, the drive shaft 29 comprises an internal channel 68 configured to connect with a channel 61 in the boss 48, and temporarily connect with a lubricant reservoir.

Connections between the channels allow distribution of lubricant, for example, from the drive shaft 29, to the boss 48 so lubricating the joint between the boss 48 and the ring 47. A temporary connection, for instance, between channels in the ring 47 and the boss 48 allows lubricant to pass through a channel 72 in the ring 47 and into channels 60′, 60″, 60′″ of the spherical coupling element 19. A temporary connection may exist between the spherical coupling element and the seating member 18′, allowing lubricant to enter the spherical joint when channels are temporarily disconnected, and to pass through the seating member 18′ channel 73 when connected. Channels 60′, 60″ in the spherical coupling element 19 temporarily connect with channels 74, 73 in the seating members 18, 18′, so that lubricant passes in the joint between the seating members 11 and the slide block. A temporary connection may exist between a channel 73 in the seating member 18′ and a channel 62 in the piston rod 10; when closed, lubricant may enter the joint between the seating member 18′ and the slide blocks 11. When opened, lubricant may pass into the piston rod 10 via a channel 62 and piston rod 10 to the piston 2′, in a partly intermittent flow. The piston rod 10 may be substantially hollow as depicted in FIG. 7, into which hollow oil is sprayed 72 from the channel 62 proximal to the swash pate 20. Oil may enter a channel 63 in the piston rod 10 distal to the swash 20, which channel be connected to a channel 64 in the piston 2′ which leads to the piston ring 67. Oils may be returned to the system by passing through a joint 71 in the piston rod 10.

When the channels temporarily disconnect, oil is transmitted to the joint, e.g. to the drive axis 29, to the boss 48/ring 47 joint, to the spherical coupling element 19, to the piston 2′/cylinder wall 65 interface.

The system of channels which temporarily connect allows oil to directly enter the spaces between joints. Furthermore, the networks of channels allow oil distribution without the need for a complex pressurized pumping system as the natural movement of the components drives the lubricant from one component to the next.

Lubricant need only to be pumped from the direction of the drive shaft 29. Once out of the drive shaft, lubricant may be driven from the drive shaft outwards by centrifugal force. The network of channels allows an efficient use of lubricant, contrary to engines of the prior art which moving parts are immersed in lubricant, requiring a larger volume of oil.

The present invention also envisages the use of ceramic coatings over the surface of joints, in addition or as an alternative to lubrication. Such coatings are known in the art, and allow reduced-friction movement of joints without the need for lubricant. Ceramics have properties of being hard wearing and resistant to heat, and as such are suited as coatings of engine parts.

Piston Rings

In the prior art, the interface between the piston and the wall of the cylinder requires thorough lubrication to avoid frictional wear of both parts. An extensive lubrication distribution system and relatively copious amounts of lubricant are needed for an optimum lubrication, which necessitates additional channels in the engine block and/or piston. Furthermore, oil is recirculated from the piston/cylinder wall interface; during combustion, the cylinder wall is blackened, and oil becomes contaminated with residue of combustion which residue is recirculated in the oil to other parts of the engine.

To overcome disadvantages in the art, a PP engine of the present invention may comprise a piston 2′ provided with a lubricated piston ring assembly 66 (FIG. 7) disposed in a groove 67 around the cylindrical surface of a piston and which contacts the cylinder wall. The lubricated piston ring assembly 66 receives just sufficient oil to lubricate the contact of the ring against the cylinder wall. The lubricated piston ring assembly maintains the piston in a central position with respect to the cylinder wall, and, as a consequence, the piston itself makes little or light contact with the cylinder wall, so little lubrication is required. Furthermore, the lubricated piston ring assembly prevents lubricating oil from entering the combustion chamber which would otherwise reduce the efficiency of combustion.

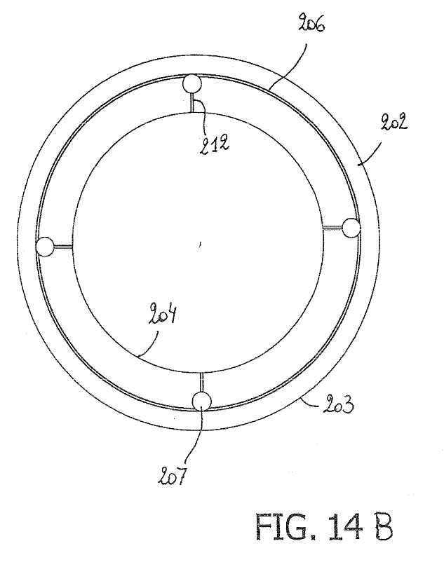

The lubricated piston ring assembly can be made from any material with the suitable compression strength to maintain the piston clear of the cylinder wall. Preferably, the lubricated piston ring assembly ring is formed from a pair of concentric rings 1302, 1303 (FIG. 13) each provided with an expansion slit 1304, 1305, and circular wick 1301. The wick 1301 can be seated in the piston groove 67, absorbing supplied lubricant. The concentric rings 1302, 1303 are placed over the wick 1301, the outermost ring 1303 contacting the cylinder wall. Lubricant is fed to the outermost ring. Referring to FIG. 13, which depicts a view of a piston, head on, the wick 1301 is disposed in a groove in the piston, over which first ring 1302 and second 1303 slitted rings are placed. Preferably, the slits are not aligned. Preferably the slits lie on the same diametric axis through the centre of the circular piston head. Preferably the concentric rings are sprung to provide outwards force in a radial direction.

Differential Cylinders

Wear and tear of the PP engine can arise through the peak forces experienced by the swash plates 20, and torsional vibrations along the drive shaft 29. Counter measures necessitate strengthening the components; however, this usually comes at the cost of increased weight, which is undesirable in efficient vehicles.

Alternatively, stronger substances such as titanium may be used in some or all of the components; however, this may render construction less economical or even uneconomical. One aspect of the present invention is a PP engine in which the distance (D1) between the central axis of the drive shaft and the coupling element (more precisely its center of rotation) for the first piston rod is different from the distance (D2) between the central axis of the drive shaft and the coupling element (more precisely its center of rotation) for the second piston rod. For example, the ratio D1/D2 is comprised between 1.01 and 3, advantageously between 1.05 and 2, preferably between 1.1 and 1.5.

This aspect of the invention can be advantageously achieved by using a cylinder distal to the flywheel which is reduced in diameter and/or (preferably and) volume relative to an opposing cylinder proximal to the flywheel and/or lying closer to the drive shaft; this arrangement enables to reduce forces on the core of the distal swash plate and torsional vibration through the drive shaft.

With reference to FIG. 8, one embodiment of the present invention is a PP engine wherein a cylinder 81, 81′ proximal to the flywheel 33 is larger in diameter than an opposing cylinder 82, 82′ (i.e. a cylinder sharing the same combustion chamber (85, 85′)) located distal to the flywheel 33. It is another aspect of the invention that a cylinder 81, 81′ proximal to the flywheel 33 is shorter in axial length than an opposing cylinder 82, 82′ located distal to the flywheel 33.

According to a further aspect of the invention, where differentially sized cylinders 81, 81″, 82, 82′ are employed, the central axis 83 of a cylinder 81′ proximal to the flywheel 33 and the central axis 84 of a cylinder 82′ distal to the flywheel are not aligned. The distal located cylinder 82° may be positioned closer Lo the drive shaft 29, so producing an eccentric combustion chamber 85, 85′ (FIG. 8).

An eccentric combustion chamber 85, 85′ provides an improved combustion space owing partly to the placement of the point of entry 810, 810′ of the fuel at the interface between the two cylinders as elaborated below. By bringing the distal located cylinders 82, 82′ closer to the drive shaft 29, the forces on the swash plate are reduced as already mentioned above. Furthermore, less power is transmitted to the flywheel 33 from the distal location, which reduces torsional vibrations along the drive shaft 29. More power is provided by cylinders 81, 81′ proximal to the flywheel 33; by placing the more powerful cylinders 81, 81′ closer to the flywheel 33, less torsional vibrations arise in transmitting torque the short distance to the flywheel 33.

According to one aspect of the invention, the distally located cylinder 82, 82′ (with respect to the flywheel) is for example 10%, 20%, 30%, 40%, 50%, 60%, 70% smaller in volume than the proximally located cylinder, or a value in the range between any of the two aforementioned values. Preferably it is between at least 10% % smaller, most preferably at least 20% smaller.

According to another aspect of the invention, the distally located cylinder 82, 82′ is 10%, 20%, 30%, 40%, 50%, 60%, 70% smaller in diameter than the proximally located cylinder, or a value in the range between any of the two aforementioned values. Preferably it is between at least 10% smaller in diameter, such as most preferably between 10% and 50% smaller in diameter.

Point of Fuel Entry

It has been found that placing the point of entry 810, 810′ of the fuel at the interface between the eccentric chamber portions facilitates the ideal of the stratified charge i.e. the fuel remains rich in the vicinity of the point of entry, and lean distal thereto; the explosion occurs while the fuel is locally rich, and burns outwards as distal oxygen in the chamber is consumed. The overall fuel mixture is lean, while the explosion is consistent with a rich fuel mix. Furthermore, because fuel is not dispersed, it is not deposited on the pistons so unburned fuel and/or charring are avoided.

Compressor

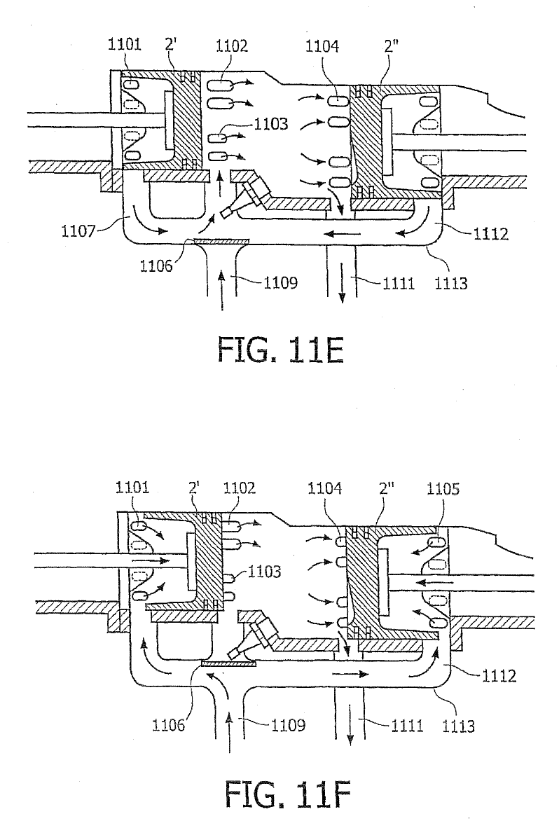

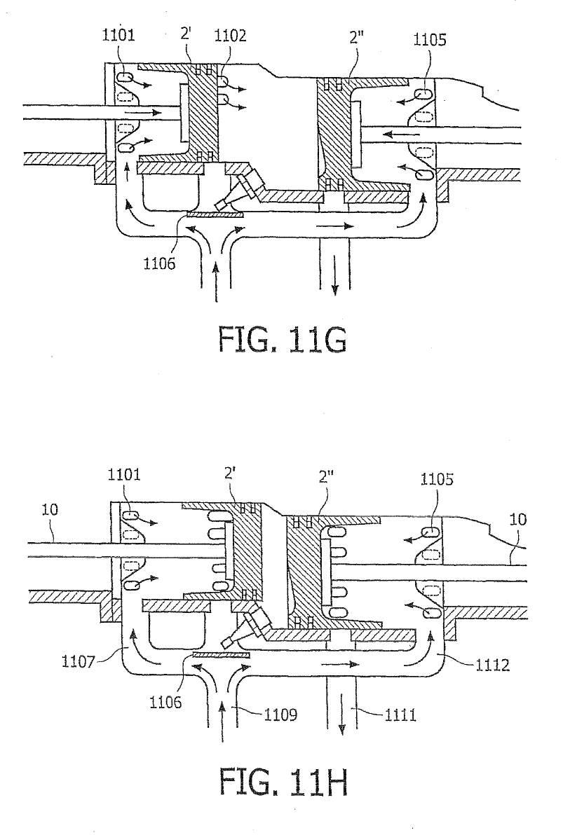

One embodiment of the present invention is a PP engine, provided with a mechanically driven compressor coupled to a ring of a swash plate. In description of the compressor reference is made to FIGS. 9 and 10, where FIG. 9 is a view of the swash plate and selected elements from the perspective of Y of FIG. 10. One embodiment of the present invention is a PP engine wherein a ring 47 of a swash plate is coupled to a mechanically-driven compressor 1002, and provides energy to said compressor while the PP engine is operating. The coupling 91 may be any which transmits translational and/or rotational movement to drive the compressor 1002. For example, the ring 47 of the swash plate may be provided with one or more spherical couplings 19 located in the spaces between the slide block connections to the piston rods, to which a compressor coupling 91 connects. Movement may be transmitted to the compressor 1002 by a conducting means 1005, such as a rod. The mechanically-driven compressor may provide injection of fuel mixtures e.g. petrol, LPG, diesel via suitable tubing 92 to inlets couplings 93 of the combustion the combustion chambers at the appropriate time.

Indented Piston Surface

In conventional PP engines, the point of entry of the fuel 810, 810′ is located in the combustion chamber 85, 85″ (FIG. 8) close to the outer circumference of a piston 2′, 2″, 3′, 3″, contrary to a conventional, perpendicularly arranged piston engines where the point of entry is roughly central to the piston surface. The explosion in a PP engine, therefore, is more intensely experienced on the portion of the piston surface closer point of entry of the fuel 810, 810′, while less so on the opposing portion. This results in an unevenness in the wear of the piston surface.

Furthermore, the piston 2′, 2″, 3′, 3″ is temporarily knocked against the wall of the cylinder 81, 81′, 82, 82′, owing to a sideward component of the force of the explosion. The knock can lead to a distortion in the shape of the piston and/or additional wear to the piston ring.

One embodiment of the present invention is a PP engine wherein a piston 2′, 2″, 3′, 3″ head surface is provided with an indent 87, 88 which is deeper towards the centre of the piston head surface. Preferably, the indent is deeper in the vicinity of the point of entry of the fuel 810, 810′ and/or of the spark plug 86, 86′. It may shallow out in the direction away from the fuel entry point. In the case of a PP engine with differential cylinders, the larger piston 2″, 3″ can lie closer to the fuel entry point 810, 810′. The indent 87 may, therefore, be deeper in the larger piston 2″ surface in the vicinity of the spark plug 86′ and shallow out in the direction away from the spark plug. The smaller piston 2′, 3′ surface, being further from the point of fuel entry 810, 810′, may be disposed with an essentially even-depth indent 88.

The optimum size and shape of the indent can be derived from using methods of the art and knowledge of the shape and design of the combustion chambers.

The indent changes the force-receiving characteristics of the piston head surface so that the energy generated by the explosion is more evenly distributed. There is a reduction in sideways knocking, and local wear.

Compression Ratio.

With reference to FIG. 8, the space 38 between elements 34 and 35 of the fly wheel 33 can be changed by the user. The element 34 can be provided with a set of bolts 89 which are configured to move the element 34 away from element 35, so changing the volume of the space 38. By increasing the space 38, through the intermediary of a cylindrical body 39 attached to element 34, the position of the swash plate 20 proximal to the flywheel 33 can be adjusted. The boss 48 of swash plate 20 abuts the transverse face of the cylindrical body 39 which forms a unit with the element 35 of the fly wheel 33. By varying the volume of space 38, the swash plate 20 can be moved in the direction of the arrows 46′ or 46″ to vary compression between pistons 2,2′ and 3, 3′. This adjustment allows the PP engine to be used with different types of fuel (e.g. petrol, diesel, ethanol, LPG etc).

Turbo Pressure

The engine of the present invention may be provided with a turbocharger. The turbo charger supplies additional air to the combustion chamber allowing a more efficient fuel combustion. Turbo charger devices are known in the art; they are generally light weight components powered by hot exhaust gases that compress in the combustion chamber above atmospheric pressure, greatly increasing the volumetric efficiency beyond that of naturally-aspirated engines. It is as aspect of the invention that the air outlet of the turbocharger device is disposed with a valve that remains closed until generated pressure reaches a predetermined level. Such valve means the turbocharger is unconnected to the combustion chamber until the engine produces sufficiently hot exhaust gasses to power the turbocharger.

According to one embodiment of the present invention, the turbo air inlets 1102 (FIG. 10) are aligned circumferentially in the wall of the combustion chamber 82″. The axial position of the aligned turbo air inlets 1102 is such that they are fully open when the piston 21 is retracted, and are partially open when the regular (atmospheric) air inlets 1103 are fully closed. The arrangement of turbo air inlets allows, the piston itself acts as a valve to open and close the turbo air inlets, so precluding the requirement for a synchronized turbo air inlet mechanism. The points at which the turbo air inlets close partly determine the pressure of combustion air, and can be optimized according to the knowledge of the skilled person. Further explanation is given below regarding the turbo air inlet in the cycle of the engine.

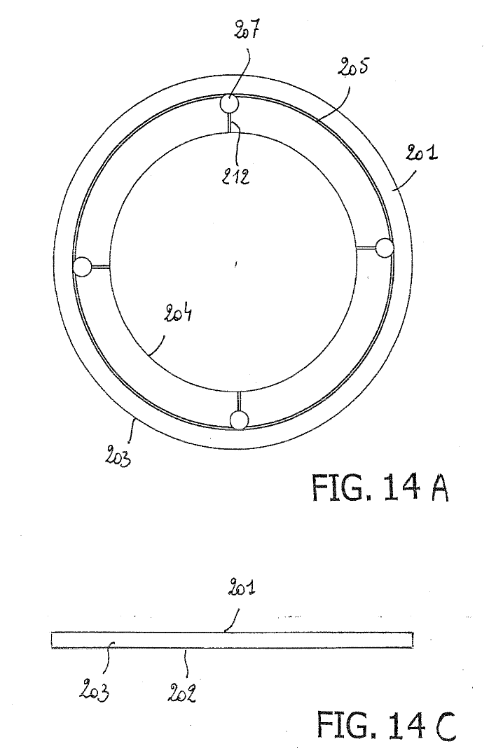

The turbocharger may be provided with a one way valve, such as a reed valve, configured to close the path from the turbocharger to the turbo air inlets 1102 until sufficient air pressure is generated by the turbo generator. An illustration of a configuration of such valve and ports is given in FIG. 12, which depicts a transverse cross section though the regular air and turbo air inlets. Pressured air from the turbo charger is delivered though a duct 1202 disposed with two one way valves 1201,1201′, each leading to a set of turbo air inlet ports 1102,1102′ of cylinders 82 and 82′. The regular air inlet ports 1103, shown here are elaborated further below. The valves 1201,1201′ remain sprung in the closed position. Once sufficient turbo air pressure has built up in the duct 1202, air pressure forces the valves open so turbo air flows through the turbo air inlets 1102,1102′ and into the respective cylinders 82, 82′. Also shown in FIG. 12 are the spark-plugs 86, 86′ and regular air inlet ports 1103 which are elaborated further below. The use of a valved turbo system allows the combustion chamber to use regular air while the turbo charger is warming up, without losses due to air exiting through the turbo air inlets.

Air Inlet and Exhaust Ports

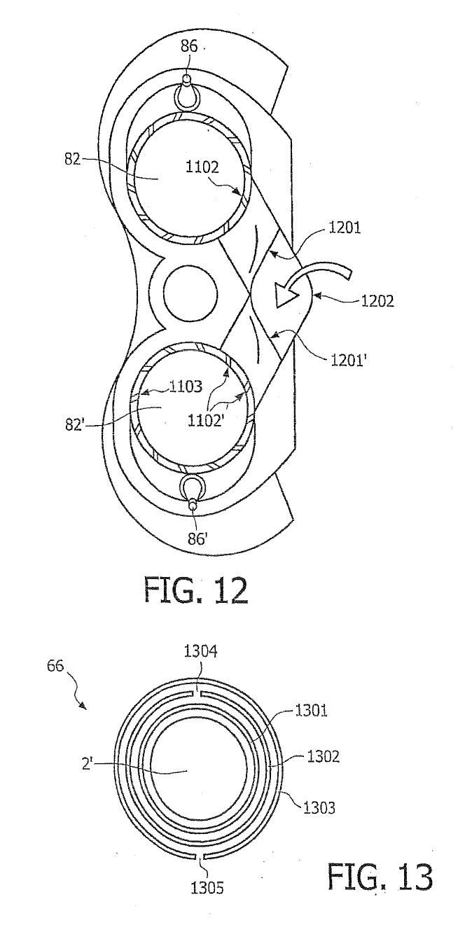

According to one embodiment of the present invention, the regular air inlets 1103 and exhaust ports 1104 are aligned circumferentially in the wall of the combustion chamber 82′, 81′. With reference to FIG. 11A, the regular air inlets 1103 and turbo air inlets 1102 are aligned around the circumference of one cylinder 82′, and the exhaust ports 1104 are aligned around the circumference of the other cylinder 81′. The axial position of the regular air inlets 1103 is such that they are fully open when the piston 2f is retracted (FIG. 11E), and close when the piston 21 moves forward (FIG. 11B). The axial position of the exhaust ports is such that they are fully open when the piston 2′ is retracted (FIG. 11E), and close when the piston 2′ moves forward (FIG. 11B). The points at which the inlet 1103 and exhaust 1104 close partly determine the pressure of combustion air, and can be optimized according to the knowledge of the skilled person. Preferably, the axial position of the regular air inlets 1103 and exhaust ports 1104 are symmetrically arranged in each cylinder so that both inlet and exhaust ports open and close at the same time when both swash plates are aligned on the drive axis at 0°, i.e. there is no timing advance of one cylinder. However, an advance of one piston is within the scope of the invention (see below) The inlet and exhaust port arrangement allows, the piston itself acts as a valve to open and close the regular air inlet and exhaust, so precluding the requirement for synchronized air inlet and outlet driving mechanism.

Furthermore, the distribution and plurality of inlets and exhaust ports means combustion chamber is well aerated compared with conventional designs where the fuel mixture enters and exits from a single point. Furthermore, the separation of the fuel inlet from the air inlet allows for a stratified charge where a rich mixture is exploded close to the point of entry, burning oxygen located distal to the point of fuel entry, as already described above.

In a further instance, where the engine is disposed with a turbocharger the turbo air inlets 1102 to the combustion chamber from said turbocharger may be aligned in the same circumferential ring as the regular air inlets 1103 (FIG. 11A).

Furthermore, the axial length of the turbo-air inlets 1102 may be longer in the direction towards the exhaust ports than that of the regular air inlets 1103. By extending the length, turbo-charged air can continue to enter the chamber even when the regular ports have been closed by the piston (e.g. FIG. 11G). Such configuration allows the introduction of turbocharged air without additional synchronization mechanisms to control and timing of air flow.

Use of Void Air

Air may be brought through the regular air inlets 1103 under slight pressure. Pressurized delivery can by means of a typical air pump. Alternatively, the air entering the combustion chamber may be that air displaced from the void or free space behind cylinder during the retracting motion of the piston. Utilizing displaced air dispenses with the need for an external air pumping device, so economizing engine design and efficiency. Furthermore, air is already warmed due to the location of the void or free space within the engine block.

FIG. 11A shows a possible configuration of air inlets and exhaust ports which utilize void air. Atmospheric air is able to enter the void or free space behind the each piston via a plurality of void airports 1101 and 1105. Void airports 1101,1105 of a set of opposing cylinders (e.g. 81′, 82′) may be joined by means of ducting (1113), said ducting connecting to a atmospheric air inlet 1109, and also to the combustion chamber air inlet ports 1103.

A valve 1106 may control the flow of air, allowing atmospheric air to be drawn into the voids 1114, 1115 during the forward motion of the piston and to close the atmospheric air inlet 1109 during the backward motion of the piston. The valve may also close inlet to the combustion chamber 1108 during forward motion of the piston so that air filling the void is fresh i.e. arriving from the atmospheric air inlet 1109, and not from the combustion chamber. The valve may be operated according to the pressure experience in the void 1114, 1115, e.g. a vacuum during forward piston motion, and positive pressure during retraction.

As with the combustion chamber inlets, void air ports 1101, 1105 may be circumferentially aligned around the cylinder. Preferably, they are axially aligned to close when a piston is fully retracted (FIG. 11E), and open as the piston moves forward (FIG. 11F).

Cycle of the Engine

With reference to FIG. 11B to 11H, a cycle of the engine is depicted. FIG. 11B depicts the engine as the pistons approach the most fully forward position; atmospheric air is drawn though the atmospheric air inlet 1109, via a coupling 1107 to one set of void air ports 1101, and via another coupling 1112 to another set of void air ports 1105. Air is prevented from entering the combustion chamber inlet 1108, due to the valve 1106.

In a next stage, after combustion, in FIG. 11C, pistons 2″, 2″ start to retract. Air from the voids 1114, 1115 behind the pistons 2′, 2″ is forced out via the void air ports 1101, 1105 and through the couplings 1107, 1112 into ducting 1113. The valve 1106 prevents air displaced from the voids 1114, 1115 venting to the atmosphere by closing the atmospheric air inlet 1109.

Where the exhaust side piston 2′ is set in advance of the air inlet side piston 2″ (see below), the exhaust ports 1104 open before the regular air inlet ports. Therefore, pressurized exhaust gases leave via the exhaust channel 1111, and do not contaminate incoming combustion air.

In the next stage (FIG. 11D), pistons 2′, 2″ continue to retract, opening elongated turbo-air inlets 1102, so combustion gases are flushed from the chamber when the turbocharger is operating i.e. when the engine is sufficiently warm to provide air pressure. Pressurized air displaced from the voids or free spaces 1114, 1115 continues to build up in the ducting 1113.

When the pistons 2′, 2″ are further retracted (FIG. 11E), the piston 2′ uncovers the regular air inlets 1103, so air held in the duct 1113 is released into the combustion chamber. Concomitantly, exhaust gasses leave via the exhaust ports 1104.

As the pistons start their forward movement (FIG. 11F), the voids or free spaces behind the pistons fill again with atmospheric air, and the valve 1109 opens the atmospheric air inlet 1109, and closes the combustion chamber inlet 1108. The exhaust ports 1104 start to close before the regular air inlet ports 1103, when exhaust side piston 2′ is set in advance of the air inlet side piston 2″ (see below).

The turbo air inlet 1102 continues to pump air into the chamber.

At the point where the regular air inlets 1103 and exhaust ports 1104 are closed off by the pistons 2′, 2″ (FIG. 11G), the turbo inlets 1102 still provide air to the chamber by virtue of their length in the axial direction. As a consequence, the air pressure in the chamber continues to rise to the benefit of lean combustion. When the turbo is not operating, the pressure in the chamber is lower; air is prevented from exiting via the turbo air inlet 1102 due to a one way valve 1201, 1201′ present in the turbo system as described above.

When the pistons 2′, 2″ are most fully forward (FIG. 11H), the inlets and exhaust ports to the combustion chamber are sealed off for the explosion to occur.

Cylindrical Advance

As already mentioned above, the timing of pistons can be set so that one piston in an opposing set moves in advance of another. Preferably, the piston 2″ in a chamber disposed with exhaust ports 1104 moves slightly in advance of the piston 2′ in the chamber disposed with air inlet ports 1103. The advancement is achieved by varying the angle of alignment (advancement angle) between a pair of opposed swash plates aligned on the drive axis. Where there is no advancement, the angle is at 0 deg. Where the angle is, for example, 5 deg, one piston is said to be 5 deg advanced. According to one aspect of the invention, the piston 2″ in the chamber disposed with exhaust ports 1104 is more than 0°, such as about 1°, 2°, 3°, 4°, 5°, 6°, 7°, 8°, 9°, 10°, 11°, 12°, 13°, 14°, 15°, 16°, 17°, 18°, 19°, or 20° advanced, or a value in the ranged between any two of the aforementioned angles. Preferably said piston is more than 0° and less than 10° advanced, most preferably comprised between 1° and 8°.

One embodiment of the present invention is fuel engine comprising at least one pair of pistons arranged to move along axes parallel to the central axis of the drive shaft, in which said pair of pistons (2′, 2″, 3′, 3″) share the same combustion chamber (85, 85′), and a linear motion of piston rods (10) rotate a drive shaft (29) by means of two swash plates (20,20′) each comprising a central boss (48) and ring (47) assembly and one or more spherical coupling elements (19) disposed on said ring, wherein the distance, d1, between bearings (49, 50) disposed either side of the ring (47) is maximized.

For maximizing said distance, the distance between the bearings is substantially equal to the inner diameter of the ring (47) divided by the tangent of the angle formed between the axis of rotation of the ring and the central axis of the drive shaft (29).

Another embodiment of the present invention is fuel engine comprising at least one pair of pistons arranged to move along axes parallel to the central axis of the drive shaft, in which said pair of pistons (2′, 2″, 3′, 3″) share the same combustion chamber (85, 85′), and a linear motion of piston rods (10) rotate a drive shaft (29) by means of two swash plates (20, 20′) each comprising a central boss (48) and ring (47) assembly and one or more spherical coupling elements (19) disposed on said ring, wherein a central axis (Y-Y′—FIG. 6) of a boss bore (31) and an axis of rotation (X-X′—FIG. 6) of the boss adopt an angle, alpha, preferably in the range of 20 to 25°.

Another embodiment of the present invention is a fuel engine comprising at least one pair of pistons arranged to move along axes parallel to the central axis of the drive shaft, in which said pair of pistons (2′, 2″, 3′, 3″) share the same combustion chamber (85, 85′), and a linear motion of piston rods (10) rotate a drive shaft (29) by means of two swash plates (20, 20′) each comprising a central boss (48) and ring (47) assembly and one or more spherical coupling elements (19) disposed on said ring, wherein the pistons connected to a swash plate are configured such that distance, d2, between the longitudinal axis of the drive shaft (29), and the longitudinal axis of each piston rod (10) is minimized.

Another embodiment of the present invention is a fuel engine comprising at least one pair of pistons arranged to move along axes parallel to the central axis of the drive shaft, in which said pair of pistons (2′, 2″, 3′, 3″) share the same combustion chamber (85, 85′), and a linear motion of piston rods (10) rotate a drive shaft (29) by means of two swash plates (20, 20′) each comprising a central boss (48) and ring (47) assembly and one or more spherical coupling elements (19) disposed on said ring, wherein one or more of the spherical coupling elements (19) of a swash plate (20), the ring (48), the connected boss (48), the drive shaft (29), seating members (18′), the connected piston rod (10), or the piston head comprise at least one internal channel for the passage of lubricating oil.

Another embodiment of the present invention is a fuel engine as described above, wherein two more of said channels are connected.

Another embodiment of the present invention is fuel engine as described above, wherein said connections are temporary.

Another embodiment of the present invention is a fuel engine comprising at least one pair of pistons arranged to move along axes parallel to the central axis of the drive shaft, in which said pair of pistons (2′, 2″, 3′, 3″) share the same combustion chamber (85, 85′), and a linear motion of piston rods (10) rotate a drive shaft (29) by means of two swash plates (20, 20′) each comprising a central boss (48) and ring (47) assembly and one or more spherical coupling elements (19) disposed on said ring, wherein said engine comprises a lubricated piston ring assembly ring formed from a pair of concentric rings (1302,1303) each provided with an expansion slit (1304, 1305), and a circular wick (1301) concentrically arranged within said rings (1302,1303), disposed in a groove (67) around the cylindrical surface of a piston and which contacts a cylinder wall (65).

Another embodiment of the present invention is fuel engine comprising at least one pair of pistons arranged to move along axes parallel to the central axis of the drive shaft, in which said pair of pistons (2′, 2″, 3′, 3″) share the same combustion chamber (85, 85′), and a linear motion of piston rods (10) rotate a drive shaft (29) by means of two swash plates (20, 20′) each comprising a central boss (48) and ring (47) assembly and one or more spherical coupling elements (19) disposed on said ring, wherein a cylinder (81, 81′) proximal to a flywheel (33) is larger in volume than an opposing cylinder (82, 82′) located distal to the flywheel (33).

Another embodiment of the present invention is a fuel engine comprising at least one pair of pistons arranged to move along axes parallel to the central axis of the drive shaft, in which said pair of pistons (2′, 2″, 3′, 3″) share the same combustion chamber (85, 85′), and a linear motion of piston rods (10) rotate a drive shaft (29) by means of two swash plates (20, 20′) each comprising a central boss (48) and ring (47) assembly and one or more spherical coupling elements (19) disposed on said ring, wherein a cylinder (81, 81′) proximal to a flywheel (33) is larger in diameter than an opposing cylinder (82, 82′) located distal to the flywheel (33).

Another embodiment of the present invention is a fuel engine as described above wherein a central axis (83) of a cylinder (81′) proximal to the flywheel (33) and the central axis (84) of a cylinder (82′) piston rod (10) distal to the flywheel are not aligned, and the latter being closer to the drive shaft (29), so providing an eccentric combustion chamber.

Another embodiment of the present invention is a fuel engine as described above wherein the fuel entry point (810, 810′) is positioned at an interface between the larger (81′) and smaller (82′) cylinders.

Another embodiment of the present invention is a fuel engine comprising at least one pair of pistons arranged to move along axes parallel to the central axis of the drive shaft, in which said pair of pistons (2′, 2″, 3′, 3″) share the same combustion chamber (85, 85′), and a linear motion of piston rods (10) rotate a drive shaft (29) by means of two swash plates (20, 20′) each comprising a central boss (48) and ring (47) assembly and one or more spherical coupling elements (19) disposed on said lo ring, wherein a ring (47) of a swash plate is coupled to a mechanically-driven compressor (1002) suitable for injecting fuel and/or air mixtures.

Another embodiment of the present invention is a fuel engine comprising at least one pair of pistons arranged to move along axes parallel to the central axis of the drive shaft, in which said pair of pistons (21, 2″, 3′, 3″) share the same combustion chamber (85, 85′), and a linear motion of piston rods (10) rotate a drive shaft (29) by means of two swash plates (20, 20′) each comprising a central boss (48) and ring (47) assembly and one or more spherical coupling elements (19) disposed on said ring, wherein a piston (21, 2″, 3′, 3″) head surface is provided with an indent (87, 88) which is deeper towards the center of the piston head surface.

Another embodiment of the present invention is a fuel engine as described above, wherein said indent (87) is deeper in the vicinity of fuel entry point (810, 810′) and shallows out in the direction away from the fuel entry point.

Another embodiment of the present invention is a fuel engine comprising at least one pair of pistons arranged to move along axes parallel to the central axis of the drive shaft, in which said pair of pistons (2′, 2″, 3′, 3″) share the same combustion chamber (85, 85′), and a linear motion of piston rods (10) rotate a drive shaft (29) by means of two swash plates (20, 20′) each comprising a central boss (48) and ring (47) assembly and one or more spherical coupling elements (19) disposed on said ring, wherein a flywheel (33), attached to the end of the drive shaft (29) comprises two coaxial elements (34) and (35), element (35) is attached to the drive shaft, element (35) is able to slightly slide along the drive shaft (29) but does not rotate with the drive shaft (29), element (34) is provided with a set of bolts (89) configured to move the element (34) away from element 35, so changing the volume of the space (38), which, by increasing the space (38), through the intermediary of a cylindrical body (39) attached to element (34), the position of the swash plate (20) proximal to the flywheel (33) can be adjusted.

Another embodiment of the present invention is fuel engine comprising at least one pair of pistons arranged to move along axes parallel to the central axis of the drive shaft, in which said pair of pistons (21, 2″, 3′, 3″) share the same combustion chamber (85, 85′), and a linear motion of piston rods (10) rotate a drive shaft (29) by means of two swash plates (20, 20″) each comprising a central boss (48) and ring (47) assembly and one or more spherical coupling elements (19) disposed on said ring, wherein regular air inlets (1103) and/or exhaust ports (1104) are aligned circumferentially in the wall of the combustion chamber (82′, 81″), such that the cylindrical wall of a piston positioned thereover closes said air inlets and exhaust ports.

Another embodiment of the present invention is a fuel engine as described above, wherein the axial position of the regular air inlets (1103) is such that they are fully open when a piston (2″) distal to the flywheel is retracted, and close when said piston (2′) moves forward.

Another embodiment of the present invention is a fuel engine as described above, wherein the axial position of the exhaust ports is such that they are fully open when the piston (2′) proximal to the flywheel is retracted, and close when said piston (2′) moves forward.

Another embodiment of the present invention is a fuel engine comprising at least one pair of pistons arranged to move along axes parallel to the central axis of the drive shaft, in which said pair of pistons (2′, 2″, 3′, 3″) share the same combustion chamber (85, 85′), and a linear motion of piston rods (10) rotate a drive shaft (29) by means of two swash plates (20, 20′) each comprising a central boss (48) and ring (47) assembly and one or more spherical coupling elements (19) disposed on said ring, said fuel engine further comprising a turbocharger.

Another embodiment of the present invention is a fuel engine as described above, wherein an air outlet of the turbocharger is disposed with a valve that remains closed until generated pressure reaches a predetermined level.

Another embodiment of the present invention is a fuel engine as described above, wherein the turbo air inlets (1102) are aligned circumferentially in the wall of the combustion chamber (82′) in the same circumferential ring as the regular air inlets (1103).

Another embodiment of the present invention is a fuel engine as described above, wherein the turbo air inlets (1102) are longer in the direction towards the exhaust ports than the regular air inlets (1103).

Another embodiment of the present invention is a fuel engine comprising at least one pair of pistons arranged to move along axes parallel to the central axis of the drive shaft, in which said pair of pistons (2′, 2″, 3′, 3″) share the same combustion chamber (85, 85′), and a linear motion of piston rods (10) rotate a drive shaft (29) by means of two swash plates (20, 20′) each comprising a central boss (48) and ring (47) assembly and one or more spherical coupling elements (19) disposed on said ring, wherein said engine is configured such that air entering the combustion chamber through the regular air inlets (1103) comprises the air displaced from a void (1114,1115) behind a piston (2′, 2″) during the retracting motion of the piston (2′, 2″).

Another embodiment of the present invention is a fuel engine comprising at least one pair of pistons arranged to move along axes parallel to the central axis of the drive shaft, in which said pair of pistons (2′, 2″, 3′, 3″) share the same combustion chamber (85, 85′), and a linear motion of piston rods (10) rotate a drive shaft (29) by means of two swash plates (20, 20′) each comprising a central boss (48) and ring (47) assembly and one or more spherical coupling elements (19) disposed on said ring, wherein said engine is configured such that the piston proximal to the flywheel moves in advance of the piston distal thereto.

Another embodiment of the present invention is a fuel engine as described above, wherein said advance is more than 0° and less than 10°.

Another embodiment of an engine of the invention is an engine comprising three different combustion chambers placed around the central axis of the drive shaft 29. In such an embodiment the central axis of the combustion chambers will be distant the one from the other by an angle of 120° with respect to the central axis of the drive shaft.

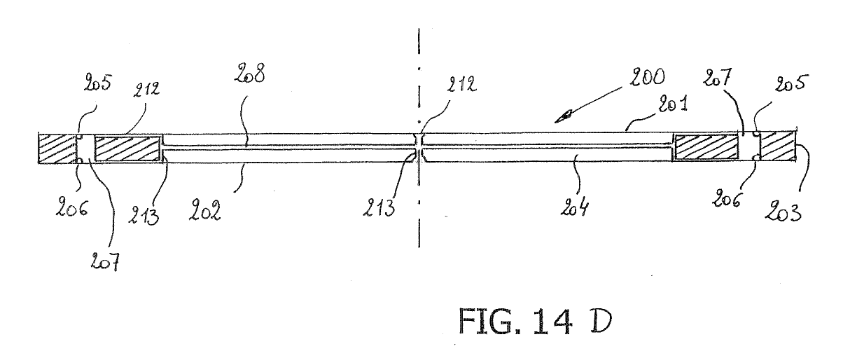

FIGS. 14A to D represent a slide bearing 200 in the form of a ring, said bearing is adapted for replacing one or more of the bearings 49, 50 of the embodiment shown in the FIGS. 1 to 13, or adapted for being used in combination with such bearings 49, 50.

The slide bearing 200 is advantageously made of a material adapted to be at least partly self lubricated, such as a porous material containing lubricant, a matrix comprising solid lubricant, etc.

The slide bearing 200 is advantageously a flat ring with an upper face 201, a lower face 202, an outer substantially circular face 203 and an inner substantially circular face 204. The lower face and the upper face are provided with grooves 205, 206 connected the one with the other by one or more holes 207, whereby oil can flow from one groove to the other groove.

The inner circular edge 204 is provided with a groove 208 for lubricating the contact surface of the body 48 in contact with said edge.

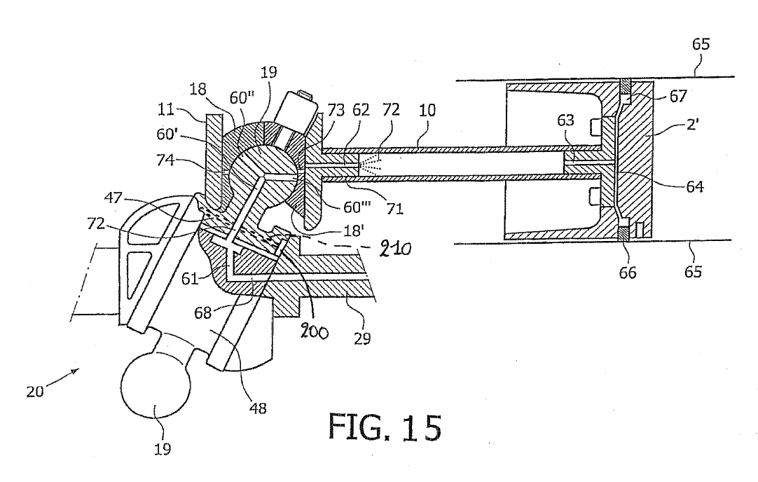

Oil is directed towards the grooves 205, 206 and 208 through a channel 210 of the piece 47, said channel communicating with the channels 60′, 61 and 68. (See FIG. 15) The channel 60′ is intended to fill the holes 207 acting as reservoir for filling channels 205 and 206, as well as 212 adapted for flowing oil towards the inner edge 204, and most precisely towards the channel 213 located on the inner edge face for guiding oil towards the groove 208.

What I claim is:

1. A fuel engine comprising:
a drive shaft having a central axis;
at least one combustion chamber comprising at least one inlet for an oxygen containing gas and at least one outlet for combustion gases;
at least a first piston and a second piston arranged each to move along axes parallel to the central axis of the drive shaft, in which said first and second pistons share the same combustion chamber,
whereby the first piston is provided with a first piston rod adapted to rotate the drive shaft by means of a swash plate comprising a central assembly with a ring and at least one substantially spherical coupling element disposed on said ring, said coupling element on which the first piston rod or an element attached to the first piston rod is connected being distant of a distance from the central axis, while the second piston is provided with a second piston rod adapted to rotate the drive shaft by means of a swash plate comprising a central assembly with a ring and one or more substantially spherical coupling elements disposed on said ring, said coupling element on which the second piston rod or an element attached to the second piston rod is connected being distant of a distance from the central axis,
in which the combustion chamber comprises a first portion in which the first piston is adapted to move, said first portion having a central axis, and a second portion in which the second piston is adapted to move, said second portion having a central axis, whereby the respective central axes of said first and second portions of the combustion chamber are not aligned.

2. The fuel engine of claim 1, in which the first piston rod of the first piston has an axis located at a first distance from the central axis of the drive shaft, while the second piston rod of the second piston has an axis located at a second distance from the central axis of the drive shaft, said second distance being different from the first distance.

3. The fuel engine of claim 2, in which, for the distances separating the central axis of the drive shaft from the axis of the first and second rods, the ratio first distance/second distance is comprised between 1.01 and 3.

4. The fuel engine of claim 1, in which the first piston rod of the first piston has an axis located at a first distance from the central axis of the drive shaft, while the second piston rod of the second piston has an axis located at a second distance from the central axis of the drive shaft, said second distance being different from the first distance, whereby, for the distances separating the central axis of the drive shaft from the axis of the first and second rods, the ratio first distance/second distance is comprised between 1.1 and 1.5.

5. The fuel engine of claim 1, in which the distance between the central axis of the drive shaft and the coupling element for the first piston rod is different from the distance between the central axis of the drive shaft and the coupling element for the second piston rod, and in that the ratio D1/D2 is comprised between 1.05 and 2, in which D1 is the distance between the central axis of the drive shaft and the coupling element for the first piston rod, while D2 is the distance between the central axis of the drive shaft and the coupling element for the second piston rod.

6. The fuel engine of claim 1, in which the distance between the central axis of the drive shaft and the coupling element for the first piston rod is different from the distance between the central axis of the drive shaft and the coupling element for the second piston rod, and in that the ratio D1/D2 is comprised between 1.1 and 1.5, in which D1 is the distance between the central axis of the drive shaft and the coupling element for the first piston rod, while D2 is the distance between the central axis of the drive shaft and the coupling element for the second piston rod.

7. The fuel engine of claim 1, in which the combustion chamber comprises a first portion in which the first piston is adapted to move, said first portion having a first maximal expansion volume, and a second portion in which the second piston is adapted to move, said second portion having a second maximal expansion volume, whereby the maximal expansion volume central axis of said first and second portions of the combustion chamber are different.

8. The fuel engine of claim 7, in which the ratio first maximal volume/second maximal volume is comprised between 1.2 and 4.

9. The fuel engine of claim 1, in which the combustion chamber comprises a first portion in which the first piston is adapted to move, said first portion having a first maximal expansion volume, and a second portion in which the second piston is adapted to move, said second portion having a second maximal expansion volume, whereby the maximal expansion volume central axis of said first and second portions of the combustion chamber are different, and in which the ratio first maximal volume/second maximal volume is comprised between 1.8 and 2.5.

10. The fuel engine of claim 1, in which the first portion of the combustion chamber is defined by a first inner diameter, while the second portion of the combustion chamber is defined by a second diameter, the ratio first diameter/second diameter being comprised between 1.01 and 2.

11. The fuel engine of claim 1, in which the first portion of the combustion chamber is defined by a first inner diameter, while the second portion of the combustion chamber is defined by a second diameter, the ratio first diameter/second diameter being comprised between 1.07 and 1.3.

12. The fuel engine of claim 1, in which the first and second pistons are moving in the combustion chamber between a position in which the pistons are away from each other and a position in which the pistons are adjacent to each other so as to define there between at least a minimum dead volume, said minimum dead volume corresponding at least to a third portion located between the first and second portions of the combustion chamber, whereby said third portion is a portion in which the first piston and the second piston do not move.

13. The fuel engine of claim 1, in which at least one of the first and second pistons has at least one hollow zone open towards the combustion chamber, and in which the first and second pistons are moving in the combustion chamber between a position in which the pistons are away from each other and a position in which the pistons are adjacent to each other so as to define there between at least a minimum dead volume, said minimum dead volume corresponding at least to the sum of a third portion located between the first and second portions of the combustion chamber and of the at least one hollow zone of said at least one of the first and second pistons, whereby said third portion is a portion in which the first piston and the second piston do not move.

14. The fuel engine of claim 1, in which for each swash plate, the ring is mounted rotative along an axis with respect to the central assembly, by means of at least two bearings, whereby said axis forms an angle with the central axis of the drive shaft.

15. The fuel engine of claim 14, in which the axis of rotation of the ring forms an angle comprised between 10° and 50° with respect to the central axis of the drive shaft.

16. The fuel engine of claim 1, in which for each swash plate, the ring is mounted rotative along an axis with respect to the central assembly, by means of at least two bearings, whereby said axis forms an angle with the central axis of the drive shaft, and in which the axis of rotation of the ring forms an angle comprised between 15° and 40° with respect to the central axis of the drive shaft.

17. The fuel engine of claim 1, in which for each swash plate, the ring is mounted rotative along an axis with respect to the central assembly, by means of at least two bearings, whereby said axis forms an angle with the central axis of the drive shaft, and in which the ring has an inner diameter, whereby the distance between the bearings is substantially equal to the inner diameter of the ring divided by the tangent of the angle formed between the axis of rotation of the ring and the central axis of the drive shaft.

18. The fuel engine of claim 1, in which the central assembly of the swash plate adapted to rotate around an axis of rotation is provided with a bore having a central axis forming an angle with the axis of rotation, said angle being comprised between 10° and 40°.

19. The fuel engine of claim 1, in which the central assembly of the swash plate adapted to rotate around an axis of rotation is provided with a bore having a central axis forming an angle with the axis of rotation, said angle being comprised between 20° to 25°.

20. The fuel engine of claim 1, in which the pistons connected to a swash plate are configured such that the distance between the longitudinal axis of the drive shaft and the longitudinal axis of each piston rod is minimized.

21. The fuel engine of claim 1, which comprises at least one element selected from the group consisting of spherical coupling elements of a swash plate, the ring, the central assembly, the drive shaft, seating members, the connected piston rods and piston heads, whereby said at least one element comprise at least one internal channel for the passage of lubricating oil.

22. The fuel engine of claim 22, which comprises at least two elements selected from the group consisting of spherical coupling elements of a swash plate, the ring, the central assembly, the drive shaft, seating members, the connected piston rods and piston heads, whereby said at least two elements have each at least or more of said channels with one or more openings or ends adapted to form a passage therebetween.

23. The fuel engine of claim 1, which comprises at least two elements selected from the group consisting of spherical coupling elements of a swash plate, the ring, the central assembly, the drive shaft, seating members, the connected piston rods and piston heads, whereby said at least two elements have each at least or more of said channels with one or more openings or ends adapted to form temporary passage therebetween.

24. The fuel engine of claim 1, said engine further comprising a lubricated piston ring assembly.

25. The fuel engine of claim 1, said engine comprising a flywheel and a combustion chamber comprising:
(a) a cylinder proximal to the flywheel in which a first piston is moving, and
(b) a cylinder located distal to the flywheel in which a second piston is moving, said cylinder located distal to the flywheel being opposing the cylinder proximal to the flywheel,
in which the cylinder proximal to the flywheel is larger in volume than the cylinder located distal to the flywheel.

26. The fuel engine according to claim 1, said engine comprising a flywheel and a combustion chamber comprising:
(a) a cylinder proximal to the flywheel in which a first piston is moving, and
(b) a cylinder located distal to the flywheel in which a second piston is moving, said cylinder located distal to the flywheel being opposing the cylinder proximal to the flywheel,
in which the cylinder proximal to a flywheel is larger in diameter than the cylinder located distal to the flywheel.

27. The fuel engine according to claim 1, said engine comprising a flywheel and a combustion chamber comprising:
(a) a cylinder proximal to the flywheel in which a first piston is moving, said cylinder proximal to the flywheel having a first central axis, and
(b) a cylinder located distal to the flywheel in which a second piston is moving, said cylinder located distal to the flywheel being opposing the cylinder proximal to the flywheel, said cylinder located distal to the flywheel having a second central axis,
whereby the said first axis and second axis are not aligned, and whereby the second axis is closer to the drive shaft than the first axis, so providing an eccentric combustion chamber.

28. The fuel engine of claim 1, said engine comprising a flywheel and a combustion chamber comprising:
(a) a first cylinder proximal to the flywheel in which a first piston is moving,
(b) a second cylinder located distal to the flywheel in which a second piston is moving, said cylinder located distal to the flywheel being opposing the cylinder proximal to the flywheel, and
(c) an interface between the first cylinder and the second cylinder, said interface being provided with at least one fuel entry point.

29. The fuel engine of claim 1, in which at least one swash plate has a ring adapted to be coupled to a mechanically-driven compressor suitable for injecting at least one compound selected from the group consisting of fuel, air, oxygen, and mixtures thereof.

30. The fuel engine of claim 1, in which at least one piston moving in a combustion chamber is provided with a piston head surface provided with an indent.

31. The fuel engine of claim 1, in which at least one piston moving in a combustion chamber is provided with a piston head surface provided with an indent, which is deeper towards the centre of the piston head surface.

32. The fuel engine of claim 1, in which the two pistons moving in a combustion chamber are each provided with a piston head surface provided with an indent.

33. The fuel engine of claim 31, in which the combustion chamber has:
(a) at least one fuel entry point, and
(b) a piston moving in said combustion chamber between a position proximal to said fuel entry point and a position distal from said fuel entry point, said piston having a piston head surface provided with an indent deeper in the vicinity of fuel entry point and shallowing out in the direction away from the fuel entry point.

34. The fuel engine according to claim 1, comprising a flywheel attached to an end of the drive shaft, wherein said flywheel comprises at least:
(a) a first element attached to the drive shaft,
(b) a second element attached to the drive shaft, coaxial to the first element, and being able to slightly slide along the drive shaft and with respect to the first element, whereby a space with a volume is defined between the first element and the second element, and
(c) means for moving at least the second element along the drive shaft with respect to the first element, so as to change the volume of the space between the first element and the second element.

35. The fuel engine according to claim 35, in which a cylindrical body is mounted on the drive shaft, whereby said cylindrical body is connected to the swash plate proximal to the flywheel in a way that by adapting the space between the first element and the second element, the swash plate proximal to the flywheel has a position which is adjustable.

36. The fuel engine according to claim 1, in which the combustion chamber is provided with at least one regular air inlet and with at least one exhaust port, said at least one inlet and port being aligned circumferentially in the wall of the combustion chamber, such that the cylindrical wall of at least one piston, advantageously two pistons moving in the combustion chamber being adapted for closing one or more air inlets and/or exhaust ports when said cylindrical wall is positioned thereover.

37. The fuel engine according to claim 37, wherein the axial position of the at least one regular air inlet is such that the at least one regular air inlet is fully open when a piston distal to the flywheel is retracted, and closed when said piston distal to the flywheel moves forward.

38. The fuel engine of claim 1, which comprises at least two combustion chambers, each combustion chamber being provided with two moving pistons, all said pistons moving in their respective combustion chamber in a direction parallel to the central axis of the drive shaft.

39. The fuel engine of claim 1, which comprises at least three combustion chambers, each combustion chamber being provided with two moving pistons, all said pistons moving in their respective combustion chamber in a direction parallel to the central axis of the drive shaft.

40. The fuel engine of claim 1, which further comprises a turbocharger.

41. The fuel engine according to claim 41, in which the turbocharger is provided with an air outlet disposed with a valve adapted or controlled to remain closed in function of the pressure.

42. The fuel engine of claim 1 which is configured such that oxygen containing gas entering the combustion chamber through at least one inlet comprises oxygen containing gas displaced from a free space behind a piston during a retracting motion of said piston.

43. The fuel engine of claim 1, said engine comprising a flywheel, whereby for one combustion chamber, a first piston is proximal to said flywheel, while a second piston is distal to said flywheel, whereby the engine is configured such that the piston proximal to the flywheel moves in advance of the piston distal thereto.

44. The fuel engine according to claim 44, in which said advance is comprised between 0° and 10°.

45. A fuel engine comprising:
a drive shaft having a central axis;
at least one combustion chamber comprising at least one inlet for an oxygen containing gas and at least one outlet for combustion gases;
at least a first piston and a second piston arranged each to move along axes parallel to the central axis of the drive shaft, in which said first and second pistons share the same combustion chamber,
whereby the first piston is provided with a first piston rod adapted to rotate the drive shaft by means of a swash plate comprising a central assembly with a ring and at least one substantially spherical coupling element disposed on said ring, said coupling element on which the first piston rod or an element attached to the first piston rod is connected being distant of a distance from the central axis, while the second piston is provided with a second piston rod adapted to rotate the drive shaft by means of a swash plate comprising a central assembly with a ring and one or more substantially spherical coupling elements disposed on said ring, said coupling element on which the second piston rod or an element attached to the second piston rod is connected being distant of a distance from the central axis,
in which for each swash plate, the ring is mounted rotative along an axis with respect to the central assembly, by means of at least two bearings, whereby said axis forms an angle with the central axis of the drive shaft (29) comprised between 10° and 50° with respect to the central axis of the drive shaft, and
in which the ring has an inner diameter, whereby the distance between the bearing is substantially equal to the inner diameter of the ring divided by the tangent of the angle formed between the axis of rotation of the ring and the central axis of the drive shaft.

46. A fuel engine comprising:
a drive shaft having a central axis;
at least one combustion chamber comprising at least one inlet for an oxygen containing gas and at least one outlet for combustion gases;
at least a first piston and a second piston arranged each to move along axes parallel to the central axis of the drive shaft, in which said first and second pistons share the same combustion chamber,
whereby the first piston is provided with a first piston rod adapted to rotate the drive shaft by means of a swash plate comprising a central assembly with a ring and at least one substantially spherical coupling element disposed on said ring, said coupling element on which the first piston rod or an element attached to the first piston rod is connected being distant of a distance from the central axis, while the second piston is provided with a second piston rod adapted to rotate the drive shaft by means of a swash plate comprising a central assembly with a ring and one or more substantially spherical coupling elements disposed on said ring, said coupling element on which the second piston rod or an element attached to the second piston rod is connected being distant of a distance from the central axis,
in which for each swash plate, the ring is mounted rotative along an axis with respect to the central assembly, by means of at least two bearings, whereby said axis forms an angle with the central axis of the drive shaft (29) comprised between 10° and 50° with respect to the central axis of the drive shaft, and
in which the said bearings are selected among the group consisting of low friction slide bearings, self lubricating slide bearings, slide bearings provided with at least one lubrication channel, and combinations thereof.

47. A method for generating a power or driving force, in which a fuel engine is used, said fuel engine comprising:
a drive shaft having a central axis;
at least one combustion chamber comprising at least one inlet for an oxygen containing gas and at least one outlet for combustion gases;
at least a first piston and a second piston arranged each to move along axes parallel to the central axis of the drive shaft, in which said first and second pistons share the same combustion chamber,
whereby the first piston is provided with a first piston rod adapted to rotate the drive shaft by means of a swash plate comprising a central assembly with a ring and at least one substantially spherical coupling element disposed on said ring, said coupling element on which the first piston rod or an element attached to the first piston rod is connected being distant of a distance from the central axis, while the second piston is provided with a second piston rod adapted to rotate the drive shaft by means of a swash plate comprising a central assembly with a ring and one or more substantially spherical coupling elements disposed on said ring, said coupling element on which the second piston rod or an element attached to the second piston rod is connected being distant of a distance from the central axis,
in which the combustion chamber comprises a first portion in which the first piston is adapted to move, said first portion having a central axis, and a second portion in which the second piston is adapted to move, said second portion having a central axis, whereby the central axis of said first and second portions of the combustion chamber are not aligned,
whereby said method comprises at least the steps
filling of the combustion chamber with at least a fuel and an oxygen containing gas during at least a portion of the period when the pistons of the combustion chamber are moved away from each other by moving into rotation the drive shaft through the movement of the swash plates thereof,
compressing the fuel and the oxygen containing gas by moving the pistons of the combustion chamber the one towards the other by moving into rotation the drive shaft through the movement of the swash plates,
burning the fuel so as to generate combustion gases, said combustion gases generating pressure in the combustion chamber, said pressure causing the movement of the pistons away from each other, whereby generating the rotation of the drive shaft through the movement of the swash plates,
exhausting the combustion gases outside the combustion chamber at least during the movement of the pistons of the combustion chamber towards each other by moving the drive shaft in rotation through the swash plates.

48. A method for generating a power or driving force, in which a fuel engine is used, said fuel engine comprising:
a drive shaft having a central axis;
at least one combustion chamber comprising at least one inlet for an oxygen containing gas and at least one outlet for combustion gases;
at least a first piston and a second piston arranged each to move along axes parallel to the central axis of the drive shaft, in which said first and second pistons share the same combustion chamber,
whereby the first piston is provided with a first piston rod adapted to rotate the drive shaft by means of a swash plate comprising a central assembly with a ring and at least one substantially spherical coupling element disposed on said ring, said coupling element on which the first piston rod or an element attached to the first piston rod is connected being distant of a distance from the central axis, while the second piston is provided with a second piston rod adapted to rotate the drive shaft by means of a swash plate comprising a central assembly with a ring and one or more substantially spherical coupling elements disposed on said ring, said coupling element on which the second piston rod or an element attached to the second piston rod is connected being distant of a distance from the central axis,
in which the combustion chamber comprises a first portion in which the first piston is adapted to move, said first portion having a central axis, and a second portion in which the second piston is adapted to move, said second portion having a central axis, whereby the central axis of said first and second portions of the combustion chamber are not aligned,
whereby said method comprises at least the steps:
filling of the combustion chamber with an oxygen containing gas during at least a portion of the period when the pistons of the combustion chamber are moved away from each other by moving into rotation the drive shaft through the movement of the swash plates thereof,
compressing at least partly the oxygen containing gas by moving the pistons of the combustion chamber the one towards the other by moving into rotation the drive shaft through the movement of the swash plates,
injecting fuel in the combustion chamber,
burning the fuel so as to generate combustion gases, said combustion gases generating pressure in the combustion chamber, said pressure causing the movement of the pistons away from each other, whereby generating the rotation of the drive shaft through the movement of the swash plates,
exhausting the combustion gases outside the combustion chamber at least during the movement of the pistons of the combustion chamber towards each other by moving the drive shaft in rotation through the swash plates.
